(19) United States
(12) Patent Application Publication
(10) Pub. No.: US 2024/0349805 A1
(43) Pub. Date: Oct. 24, 2024

(54) AEROSOL-GENERATING SYSTEM WITH PLURALITY OF OPERATIONAL MODES

(71) Applicant: Philip Morris Products S.A., Neuchatel (CH)

(72) Inventors: Yannick BUTIN, Marin-Epagnier (CH); Enrico STURA, Palezieux-Village (CH); Maxime CHATEAU, Montlebon (FR)

(73) Assignee: Philip Morris Products S.A., Neuchatel (CH)

(21) Appl. No.: 18/577,479

(22) PCT Filed: Jul. 12, 2022
(86) PCT No.: PCT/EP2022/069510

§ 371 Date: Jan. 8, 2024

(30) Foreign Application Priority Data
Jul. 12, 2021 (EP) 21185042.5

(51) Int. Cl. A24F 40/465; A24F 40/20; A24F 40/485; A24F 40/51; A24F 40/53; A24F 40/57

(52) U.S. Cl. CPC A24F 40/465; A24F 40/51; A24F 40/53; A24F 40/57; A24F 40/20; A24F 40/485

(57) ABSTRACT

An induction heatable aerosol-generating system is provided, including: an inductive heating arrangement having an inductor and a susceptor; a power source configured to supply power to the heating arrangement; and a controller to: control power supplied from the power source to the heating arrangement, monitor an electrical control parameter, and operate the system in operational modes including at least: a calibration mode, a heating mode, a re-calibration mode, to verify or modify the relationship between the electrical control parameter and the temperature of the susceptor and to periodically or intermittently redetermine the target value of the electrical control parameter, and a safety mode, to adjust the power provided to the inductive heating arrangement in response to one or more predetermined criteria being met.

The present disclosure relates to an inductively heated aerosol-generating system configured to be controlled in a plurality of operational modes.

A growing number of aerosol-generating systems, such as e-cigarettes and heated tobacco systems, comprise an inductive heating arrangement that is configured to heat an aerosol-forming substrate to produce an aerosol. Inductive heating arrangements typically comprise an inductor that inductively couples to a susceptor. The inductor generates an alternating magnetic field that causes heating in the susceptor. Typically, the susceptor is in direct contact with the aerosol-forming substrate and heat is transferred from the susceptor to the aerosol-forming substrate primarily by conduction. The temperature of the susceptor must be controlled in order to provide for optimal aerosol generation, both in terms of the amount of aerosol generated and in terms of its composition.

Inductive heating arrangements provide contactless heating of a susceptor. This is beneficial in many circumstances, in particular when the susceptor is provided in a separate component of the system to the inductor. For the same reason, it is desirable to monitor and control susceptor temperature without requiring direct electrical connection to the susceptor and without requiring a separate, dedicated temperature sensor to be connected to the susceptor. Difficulties in monitoring temperature of a susceptor accurately may lead to overheating risks. It would be desirable to provide an inductively heated aerosol-generating system configured to provide improved temperature determination and fault mitigation.

According to an embodiment of the invention, there is provided an induction heated aerosol-generating system comprising an inductive heating arrangement having an inductor and a susceptor, a power source for supplying power to the inductive heating arrangement, and a controller configured to control power supplied from the power source to the inductive heating arrangement. The controller may also be configured to monitor an electrical control parameter. The controller may be configured to operate the aerosol-generating system in a plurality of operational modes. Preferably, the plurality of operational modes includes a calibration mode, for example to determine a target value of the electrical control parameter. Preferably, the plurality of operational modes includes a heating mode, in which power is supplied to the inductor to maintain the susceptor at an operational temperature. Preferably, the operational temperature is maintained by control of power supplied to the inductor with reference to the target value of the electrical control parameter. Preferably, the plurality of operational modes includes a re-calibration mode, for example to periodically or intermittently re-determine the target value of the electrical control parameter. Preferably, the plurality of operational modes includes safety mode, for example a mode in which the controller adjusts power provided to the inductive heating arrangement in response to one or more predetermined criteria being met, for example one or more predetermined safety criteria.

Thus, there may be provided an induction heated aerosol-generating system comprising an inductive heating arrangement having an inductor and a susceptor; a power source for supplying power to the inductive heating arrangement; and a controller configured to control power supplied from the power source to the inductive heating arrangement, and to monitor an electrical control parameter. The controller is configured to operate the aerosol-generating system in a plurality of operational modes, the plurality of operational modes including at least;
a calibration mode, to determine a target value of the electrical control parameter;
a heating mode, in which power is supplied to the inductor to maintain the susceptor at an operational temperature, the operational temperature being maintained by control of power supplied to the inductor with reference to the target value of the electrical control parameter;
a re-calibration mode, to periodically or intermittently re-determine the target value of the electrical control parameter; and
a safety mode, to adjust the power provided to the inductive heating arrangement in response to one or more predetermined criteria being met.

The plurality of operational modes may further include a pre-heating mode, to raise the temperature of the susceptor to a predetermined temperature prior to operating in a different operational mode, for example in the calibration mode or the heating mode.

The ability to operate in a plurality of operational modes allows the controller to determine control parameters and more accurately control temperature of a susceptor, and to ensure that the temperature is accurately controlled over the duration of a usage session in which a user is generating an aerosol. The controller can be programmed with instructions to operate according to different modes having different operational goals. For example, the goal of a calibration mode may be to determine a relationship between a monitorable control parameter and temperature of a remote susceptor, whereas the goal of a heating mode may be to maintain temperature of the susceptor at a desired operating temperature as closely as possible during use of the system. The goal of a re-calibration mode may be to verify or modify the relationship between the control parameter and the temperature of the susceptor, in particular without unduly interrupting a heating mode. The goal of a pre-heating mode may be to raise the temperature of the susceptor to an operational temperature, either as a precursor to the calibration mode or the heating mode. The goal of the safety mode is primarily to react to one or more signals or criteria that may indicate a potentially faulty or anomalous state, in particular where there is a risk of an overheating event. The safety mode may also be a recovery mode in which a remedial action is taken to correct a potentially faulty state, for example by instigating a calibration mode or a recalibration mode. By being capable of operation in a plurality of modes, and being configured to switch between the modes as required, an aerosol-generating system according to the invention is able to provide a more reliable and consistent user experience. Benefits may be particularly notable in aerosol-generating systems comprising an aerosol-generating device and an aerosol-generating article configured to be consumed using the device. Such an aerosol-generating article may be a disposable article and may be provided with an integral susceptor. Variability in such articles, for example in the dimensions and positions of the susceptor, and difficulties in repeatedly positioning such articles in precisely the same position within an aerosol-generating device, give rise to difficulties in controlling aerosol generation. An aerosol-generating system configured to be operated in a plurality of operational modes as described herein may significantly improve user experience and mitigate risks of overheating faults occurring.

Preferably, at least a portion of the susceptor is configured to undergo a reversible phase transition when heated, for example when heated or cooled through a specific temperature range, or a predetermined temperature range. Preferably, the controller is configured, for example during operation in the calibration mode, to identify upper and lower boundaries of the phase transition and upper and lower boundary values of the electrical control parameter associated with the upper and lower boundaries of the phase transition. Calibration may result in a target value of the electrical control parameter being determined to be a value between the upper and lower boundary values of the electrical control parameter.

During operation according to the calibration mode, the controller may be configured to perform steps of; heating the susceptor through the predetermined temperature range, allowing the susceptor to cool through the predetermined temperature range, monitoring the electrical control parameter, identifying upper and lower boundary values of the electrical control parameter associated with upper and lower boundaries of the phase transition, and determining the target value of the electrical control parameter.

During operation according to the calibration mode, the controller may be configured to perform steps of; heating the susceptor, monitoring the electrical control parameter while heating the susceptor, identifying upper and lower boundary values of the electrical control parameter associated with upper and lower boundaries of the phase transition, allowing the susceptor to cool through the predetermined temperature range, and monitoring the electrical control parameter while allowing the susceptor to cool, and determining the target value of the electrical control parameter.

The step of heating the susceptor may involve supplying power to the inductive heating arrangement. The power supplied to heat the susceptor during the calibration mode may be supplied at a duty cycle of greater than 80%, for example greater than 90%, for example 100%.

The step of allowing the susceptor to cool may involve supplying power to the inductive heating arrangement at a reduced duty cycle, and monitoring the electrical control parameter. By supplying some power during cooling, the controller can monitor values of the electrical control parameter and thereby monitor temperature of the susceptor as it cools. The step of allowing the susceptor to cool may involve supplying power to the inductive heating arrangement as pulses of energy, for example pulses of current, for example pulses of energy having a duty cycle of less than 10%, for example less than 2% or less than 1%, and monitoring values of the electrical control parameter during each of the pulses.

Preferably, the susceptor is located and/or locatable within an alternating electromagnetic field generated by the inductor. The susceptor may be configured to undergo a reversible phase transition when heated through a predetermined temperature range, a phase transition start point and a phase transition end point being identifiable by changes in the value of the electrical control parameter as the susceptor is heated through a predetermined temperature range, for example when the susceptor is heated in accordance with a calibration protocol during the calibration mode. The target value of the electrical control parameter is preferably determined to be between values of the electrical control parameter at the phase transition start point and the phase transition end point.

Advantageously, the inductive heating arrangement may exhibit a reversal in apparent resistance while undergoing the phase transition. For example, the inductive heating arrangement may exhibit a reversal in apparent conductance while undergoing the phase transition.

The system may be configured such that, the apparent resistance of the inductive heating system increases prior to onset of the phase transition, decreases on heating through the phase transition, and increases on heating beyond the end of the phase transition. Apparent conductance is the inverse of apparent resistance. Thus, the apparent conductance of the inductive heating system may decrease prior to onset of the phase transition, increase on heating through the phase transition, and decrease on heating beyond the end of the phase transition.

The electrical control parameter is preferably indicative of temperature of the susceptor, and/or indicative of a material property of the susceptor that varies as a function of temperature, and/or in which the electrical control parameter is a parameter that varies as a function of temperature of the susceptor. The electrical control parameter may be a parameter selected from the list consisting of; electrical resistance of the susceptor, apparent electrical resistance of the inductive heating arrangement, electrical conductance of the susceptor, apparent electrical conductance of the inductive heating arrangement, current supplied to the inductive heating arrangement, and power supplied to the inductive heating arrangement.

The controller may be configured to monitor at least one power parameter representative of power supplied to the inductive heating arrangement during operation. The at least one power parameter may be used as the electrical control parameter, or the at least one power parameter may be used to derive the electrical control parameter. The at least one power parameter may be, or may comprise, current supplied to the inductive heating arrangement during operation. The at least one power parameter may be, or may comprise, voltage across the inductive heating arrangement during operation.

As an example, apparent conductance of the inductive heating arrangement may be calculated by the formula σ=I/V, where σ is apparent conductivity of the inductive heating arrangement, I is current delivered to the inductive heating arrangement, and V is voltage across the inductive heating arrangement. Thus, if power is delivered at constant voltage, the apparent conductance may be determined in real time by monitoring the current and applying the formula. Both current and voltage may be monitored, and monitored values of both of these parameters used to calculate the apparent conductance. Apparent resistance is the inverse of apparent conductance, and can be calculated using the formula ρ=V/I, where ρ is the apparent resistance.

In some examples, the aerosol-generating system comprises an aerosol-generating article and an aerosol-generating device configured to receive the aerosol-generating article. The aerosol-generating article comprises an aerosol-forming substrate and the susceptor is preferably arranged in thermal communication with the aerosol-forming substrate. The aerosol-generating article may be a disposable article, for example an article resembling a conventional cigarette.

The aerosol-generating device may comprises the inductor, the controller, and a power supply for supplying power to the controller. The aerosol-generating device may further comprise a DC/AC convertor to convert direct current supplied by the power source to alternating current for supplying the inductor.

Preferably, the aerosol-generating device is configured to inductively heat an aerosol-forming substrate to generate an inhalable aerosol during a usage session.

The aerosol-generating device may be configured to detect when an aerosol-generating article has been received in the aerosol-generating device. For example, the device may be configured to detect electrical signals associated with the susceptor of the article being placed within the inductor of the device. As a further example, the device may be configured with a sensor, such as an optical sensor that detects presence of the aerosol-generating article when correctly located within the device. The aerosol-generating device may be further configured to determine whether the aerosol-generating article received in the aerosol-generating device is an article configured for use with the aerosol-generating device, preferably in which operation of the aerosol-generating device to heat the aerosol-generating article is prevented if the detected article is not configured for use with the aerosol-generating device. For example, the article may be configured to provide a specific electrical response when the susceptor, or an electromagnetic indicator, of the article interacts with an alternating electrical field generated by the inductor. Alternatively, the article may comprise a determinable marking or code to determine whether the article is configured for use with the device.

The phase transition of the susceptor may be a magnetic phase transition or a crystallographic phase transition. The phase transition is preferably a phase transition that occurs at a known temperature when the susceptor is heated by supplying power to the inductive heating arrangement. Such a phase transition may be detectable by monitoring electrical parameters of the device during operation, for example during the calibration mode, and may provide an indication of a relationship between values of the monitored electrical parameter or parameters and the actual temperature of the susceptor. This relationship may differ slightly from article to article, and also may differ depending on whether an article has been inserted into the device correctly or not. Conveniently, the phase transition may be a ferro-magnetic/paramagnetic phase transition, or a ferri-magnetic/paramagnetic phase transition, or an antiferro-magnetic/paramagnetic phase transition.

The susceptor should be capable of heating an aerosol-forming substrate quickly and efficiently. Preferably the susceptor can heat a substrate to a temperature required to generate aerosol without wasting energy in heating of the susceptor itself. It is also desirable that the susceptor may be swiftly cooled when power is reduced or turned off. Thus, dimensions and materials of the susceptor may be selected to configure the susceptor to heat the article efficiently.

The susceptor may comprise a first material that does not undergo a reversible phase transition on heating through a predetermined heating cycle, or a predetermined temperature range and a second material that does undergo a reversible phase transition when heated through the predetermined heating cycle or predetermined temperature range.

The operational temperature range, or operational temperature range, is preferably selected to optimise generation of aerosol from an aerosol-forming substrate. The operational temperature range may be set by a target operational temperature, and the system may be configured to maintain the temperature of the susceptor as close to the target operational temperature as possible. The operational temperature range may be between 100° C. and 500° C., for example between 200° C. and 400° C. Preferred operational temperature ranges may be between 300° C. and 400° C., for example between 350° C. and 390° C. The operational heating mode may have a target operational temperature of between 300° C. and 400° C., for example between 350° C. and 390° C., for example about 350° C., or 360° C., or 370° C., or 380° C.

In examples where the susceptor exhibits a reversible phase transition when heated through a predetermined temperature range, the phase transition may be a magnetic phase transition or a crystallographic phase transition. For example, the phase transition may be a ferro-magnetic/paramagnetic phase transition, or a ferri-magnetic/paramagnetic phase transition, or an antiferro-magnetic/paramagnetic phase transition. For example, the susceptor, or a portion of the susceptor may be a material that undergoes a Curie transition within the predetermined temperature range.

The susceptor may be configured for optimisation of heating efficiency, while still undergoing a reversible phase transition within the predetermined temperature range. Thus, the susceptor may comprise a first material that does not undergo the reversible phase transition during the predetermined temperature range and a second material that does undergo the reversible phase transition during the predetermined temperature range. The first material may comprise greater than 50% by volume of the susceptor, preferably greater than 60% by volume, or greater than 70% by volume, or greater than 80% by volume, or greater than 90% by volume, or greater than 95% by volume. The first material may be an iron based alloy, for example a stainless steel. The second material may be nickel or a nickel based alloy. The second material may be present as patches of material deposited onto the first material. The second material may be encapsulated by the first material. The second material may be layered onto or encapsulate the first material.

Advantageously, a target value of the electrical control parameter may be determined to correspond to a susceptor temperature no greater than a Curie temperature of a material in the susceptor. The susceptor may comprise a first susceptor material having a first Curie temperature and second susceptor material having a second Curie temperature. The second Curie temperature may be lower than the first Curie temperature. The target value of the electrical control parameter may correspond to a susceptor temperature no greater than the second Curie temperature.

The first and second susceptor materials are preferably two separate materials that are joined together and therefore are in intimate physical contact with each other, whereby it is ensured that both susceptor materials have the same temperature due to thermal conduction. The two susceptor materials are preferably two layers or strips that are joined along one of their major surfaces. The susceptor may further comprise yet an additional third layer of susceptor material. The third layer of susceptor material is preferably made of the first susceptor material. The thickness of the third layer of susceptor material is preferably less than the thickness of the layer of the second susceptor material.

The target value of the electrical control parameter may correspond to a susceptor temperature lying within a range of temperatures in which a conductance of the susceptor increases monotonically with increasing temperature. At the lower end of this range of temperatures a material in the susceptor may begin a phase change from a ferro-magnetic or ferri-magnetic state to a paramagnetic state. At the upper end of this range of temperatures the material may have completed the phase change from a ferro-magnetic or ferri-magnetic state to a paramagnetic state.

The susceptor may be formed as a unitary component, for example as an elongated pin, blade, wire, or strip, or as a sheet or mesh. The susceptor may be an elongated susceptor, having a length dimension greater than a width dimension or a thickness dimension. The susceptor may have a rectangular transverse cross-section, or a circular transverse cross-section. The susceptor may be in the form of a strip of material or a strip of foil.

The susceptor may have a length of between 8 mm and 100 mm, for example between 10 mm and 30 mm, for example between 12 mm and 20 mm. The susceptor may have a width of between 2 mm and 6 mm, for example between 3 mm and 5 mm, for example between 3.5 mm and 4.5 mm. The susceptor may have a thickness of between 0.01 mm and 2 mm, for example between 0.05 mm and 1.5 mm, for example between 0.1 mm and 1 mm.

The susceptor may be formed from a plurality of discrete components, for example from more than one elongated pins, blades, wires, or strips, more than one sheets or meshes, or more than one particle, for example the susceptor may be formed from a plurality of particles disposed in thermal contact with, or within, the aerosol-forming substrate.

The power supply may be a DC power supply, for example a battery located within the aerosol-generating device, the aerosol-generating device further comprising a DC to AC convertor, for example a DC to AC inverter, to supply AC power to the inductor.

The inductor may comprise an inductor coil. The inductor coil may be a helical coil or a flat planar coil, in particular a pancake coil or a curved planar coil. The inductor may be used to generate a varying magnetic field. The varying magnetic field may be high-frequency varying magnetic field. The varying magnetic field may be in the range between 500 kHz (kilo-Hertz) to 30 MHZ (Mega-Hertz), in particular between 5 MHz to 15 MHZ, preferably between 5 MHz and 10 MHz. The varying magnetic field is used to inductively heat the susceptor due to at least one of Eddy currents or hysteresis losses, depending on the electrical and magnetic properties of the susceptor material.

The inductive heating arrangement may comprise a DC/AC converter, the inductor connected to the DC/AC converter. The susceptor may be arranged to inductively couple to the inductor. Power from the power source may be supplied to the inductor, via the DC/AC converter, as a plurality of pulses of electrical current, each pulse separated by a time interval. Controlling the power provided to the inductive heating arrangement may comprise controlling the time interval between each of the plurality of pulses. Controlling the power provided to the inductive heating arrangement may comprise controlling the length of each pulse of the plurality of pulses.

The system may be configured to measure, at the input side of the DC/AC converter, a DC current drawn from the power source. A conductance value or the resistance value associated with the susceptor may be determined based on a DC supply voltage of the power source and from the DC current drawn from the power source. The system may further be configured to measure, at the input side of the DC/AC converter, the DC supply voltage of the power source. This is due to the fact that there is a monotonous relationship between the actual conductance (which cannot be determined if the susceptor forms part of the article) of the susceptor and the apparent conductance determined in this way (because the susceptor will impart the conductance of the LCR-circuit (of the DC/AC converter) it will be coupled to, because the majority of the load (R) will be due to the resistance of the susceptor. The conductance is 1/R. Hence, reference to the conductance of the susceptor in this text is reference to apparent conductance if the susceptor forms part of a separate aerosol-generating article.

Preferably the aerosol-generating device comprises the inductor, the controller, and a power supply for supplying power to the controller. The aerosol-generating device may further comprises a DC/AC convertor to convert direct current supplied by the power source to alternating current for supplying the inductor. The current supplied to the DC/AC convertor may be monitored and may form the electrical control parameter, or may be used in the derivation of the electrical control parameter. The aerosol-generating device may be configured to inductively heat an aerosol-forming substrate to generate an inhalable aerosol during a usage session.

In some examples, apparent resistance of the inductive heating arrangement exhibits a positive relationship with temperature immediately below the lower boundary of the phase transition and immediately above the upper boundary of the phase transition, and a negative relationship with temperature between the upper and lower boundaries of the phase transition.

In some examples, apparent conductance of the inductive heating arrangement exhibits a negative relationship with temperature immediately below the lower boundary of the phase transition and immediately above the upper boundary of the phase transition, and a positive relationship with temperature between the upper and lower boundaries of the phase transition.

Preferably, the operational temperature during the heating mode is a temperature upper and lower boundaries of the phase transition, that is, at a temperature between the phase transition starting and the phase transition ending.

Preferably the heating mode is configured to maintain the temperature of the susceptor in accordance with a predetermined temperature profile. Power may be supplied to the inductor during the heating mode as pulses of power, for example pulses of electrical current, the temperature of the susceptor being controlled by varying the duty cycle of the inductor. The controller may be configured to control the temperature of the susceptor during the heating mode with reference to a target value of apparent resistance of the inductive heating arrangement, the target value of apparent resistance being determined during the calibration mode or during the re-calibration mode. The controller may be configured to control the temperature of the susceptor during the heating mode with reference to a target value of apparent conductance of the inductive heating arrangement, the target value of apparent conductance being determined during the calibration mode or during the re-calibration mode.

The electrical control parameter may be monitored during the heating mode to verify that a value of the electrical control parameter is between upper and lower boundary values of the electrical control parameter associated with upper and lower boundaries of the phase transition. The device may be configured to operate according to a safety mode if this cannot be verified.

A response of the electrical control parameter to power supplied to the inductive heating arrangement, for example pulses of power supplied to the inductive heating arrangement, may be monitored during the heating mode to verify that the susceptor is within an operational temperature range. The device may be configured to operate according to a safety mode if this cannot be verified.

Operation according to the safety mode may involve a reduction in power supplied to the inductive heating arrangement, for example a reduction in the duty cycle supplied to the inductor, for a sufficient period of time to allow the susceptor to cool, for example cool to a temperature below the lower boundary of the phase transition.

The aerosol-generating device may comprise one or more sensors to provide feedback on operating conditions. For example, the aerosol-generating device may comprise a puff sensor to determine a user puff, for example an airflow sensor, or a temperature sensor such as a thermistor mounted within an air flow path of the aerosol-generating device.

The heating mode may comprise more than one control protocols. For example, the heating mode may be configured to operate according to either a non-puff heating regime or a puff heating regime. The controller may be configured to operate according to the puff heating regime when it is detected that a user is taking a puff during the heating mode, and to operate according to the non-puff heating regime when it is not detected that a user is taking a puff during the heating mode.

The controller may be configured to apply a limit to the power supplied to the inductive heating arrangement during the puff heating regime, for example by limiting the duty cycle to 50% of maximum duty cycle, or 60% of maximum duty cycle, or 70% of maximum duty cycle, or 80% of maximum duty cycle. This may prevent inadvertent overheating during a user puff, where the increased power requirement to maintain a temperature of the susceptor at an operating temperature increases the risk that the actual temperature of the susceptor overruns the operating temperature.

The system may be configured such that a calibration mode or a recalibration mode is terminated if it is determined that a user takes a puff during operation under the calibration mode or the recalibration mode. The controller may prevent or delay instigation of the recalibration mode if it is determined that a user is taking a puff.

The aerosol-generating system may comprise a temperature sensor located outside an airflow path in order to monitor temperature, for example temperature of an aerosol-generating device, for example a sensor such as a thermocouple or thermistor mounted on a PCB of the aerosol-generating device, or a thermocouple or thermistor mounted within a substrate receiving cavity of the aerosol-generating device.

The device may be configured to operate according to the safety mode if a temperature of a portion of the device is determined to be out of a predetermined range, or in which operation is terminated if the temperature of a portion of the device is determined to be out of a predetermined range.

The controller may be configured to interrupt the heating mode to perform a recalibration according to the re-calibration mode, preferably in which the heating mode is resumed if the recalibration is performed successfully. The re-calibration mode may be engaged periodically based on one or more criteria of: a predetermined duration of time, a predetermined number of user puffs, a predetermined number of temperature steps, and a measured voltage of the power source.

The one or more predetermined criteria of the safety mode, for example safety criteria or safety triggers, are preferably criteria relating to operational events or monitored operational parameters. The controller is preferably configured to engage the safety mode in response to one or more of the predetermined criteria being met.

For example, at least one of the one or more predetermined criteria may be that a temperature of electronic components of the aerosol-generating system exceeds a predetermined temperature. For example that temperature of a PCB of the aerosol-generating system exceeds a predetermined temperature, for example a temperature in excess of 50° C., or 60° C., or 70° C., or 80° C., or 100° C. Preferably, temperature of the electronic components is monitored by a temperature sensor mounted on or near the electronic components.

For example, at least one of the one or more predetermined criteria may be that temperature of a substrate-receiving cavity or chamber of the aerosol-generating system exceeds a predetermined temperature. For example, that temperature of a heating chamber of an aerosol-generating device exceeds a predetermined temperature, for example a temperature in excess of 400° C., or 410° C., or 450° C., or 480° C. Preferably, temperature of the cavity or chamber is monitored by a temperature sensor mounted within the substrate-receiving cavity or chamber.

For example at least one of the one or more predetermined criteria may be that temperature of the susceptor exceeds a maximum operating temperature, for example a temperature in excess of 400° C., or 410° C., or 450° C., or 480° C. This may be determined by monitoring electrical control parameters. For example, at least one of the one or more predetermined criteria may be that temperature of the susceptor exceeds a Curie temperature of a material component of the susceptor.

For example, at least one of the one or more predetermined criteria may be that a response a response of the electrical control parameter to power supplied to the inductive heating arrangement during the heating mode does not meet a predetermined condition, for example in which apparent conductance of the inductive heating arrangement does not rise in response to power supplied during the heating mode.

For example, at least one of the one or more predetermined criteria may be that voltage of the power source falls below a predetermined level.

Preferably, the temperature of the susceptor is reduced, or initially reduced, during operation according to the safety mode.

The safety mode may comprise one or more steps of; reducing power supplied to the inductive heating arrangement, terminating power supplied to the inductive heating arrangement, initiating another one of the plurality of operational modes, for example a calibration mode or a re-calibration mode, and terminating a user session.

Preferably, operating according to the safety mode comprises an adjustment to the power provided to the inductive heating arrangement, for example an adjustment to the power provided to the inductive heating arrangement in response to one or more overheating or cooling events.

In an example, the aerosol generating system may comprise an aerosol-generating device and an aerosol-generating article. The aerosol-generating device may comprise a power supply, a DC/AC converter, an inductor coil, and a controller. The aerosol-generating article may comprise an aerosol-forming substrate and a susceptor element, the susceptor element being inductively coupled to the inductor coil in use, and configured to heat the aerosol-forming substrate. The controller may be configured to:
operate in the calibration mode to calculate a range of conductance or resistance values associated with the susceptor element, corresponding to a desirable temperature range for the susceptor element based on measurements of a change in conductance or resistance associated with the susceptor element with increased power provided to the inductive heating arrangement;
operate in the heating mode to provide power to the inductive heating arrangement to maintain the conductance or resistance associated with the susceptor element at a target value within the range conductance or resistance values;
operate in the re-calibration mode to periodically or intermittently re-calculate the range of conductance or resistance corresponding to the desirable temperature range for the susceptor element based on measurements of a change in conductance or resistance with increased power provided to the inductive heating arrangement; and
operate in the safety mode to adjust the power provided to the inductive heating arrangement in response to one or more overheating or cooling events.

In preferred examples, the controller is programmed with instructions to implement any of the plurality of operational modes. The controller may comprise a memory containing executable instructions to implement any of the plurality of operational modes.

According to an embodiment of the invention, an aerosol-generating device may be provided, the aerosol-generating device being configured to be used in an aerosol-generating system as described herein.

According to an embodiment of the invention, an aerosol-generating article may be provided, the aerosol-generating article configured to be used in an aerosol-generating system as described herein.

According to an embodiment of the invention, a method of controlling an induction heated aerosol-generating system comprising an inductive heating arrangement having an inductor and a susceptor may comprise steps of;
operating the system in a calibration mode, to determine a target value of an electrical control parameter;
operating the system in a heating mode by supplying power to the inductive heating arrangement to maintain the susceptor at an operational temperature with reference to the target value of the electrical control parameter;
periodically or intermittently operating the system in a re-calibration mode, to re-determine the target value of the electrical control parameter; and
adjusting the power provided to the inductive heating arrangement in response to one or more predetermined safety criteria being met.

Preferably, at least a portion of the susceptor is configured to undergo a reversible phase transition, and the calibration mode includes the step of heating the susceptor through a predetermined temperature range to determine upper and lower boundaries of the phase transition, for example by heating the susceptor until the upper boundary of the phase transition is detected. The method may comprise the step of identifying upper and lower boundary values of the electrical control parameter associated with the upper and lower boundaries of the phase transition.

The method may be a method of controlling an aerosol-generating system as described herein.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable. An aerosol-generating article comprising an aerosol-forming substrate comprising tobacco may be referred to herein as a tobacco stick.

An aerosol-forming substrate may comprise nicotine. An aerosol-forming substrate may comprise tobacco, for example may comprise a tobacco-containing material containing volatile tobacco flavour compounds, which are released from the aerosol-forming substrate upon heating. In preferred embodiments an aerosol-forming substrate may comprise homogenized tobacco material, for example cast leaf tobacco. The aerosol-forming substrate may comprise both solid and liquid components. The aerosol-forming substrate may comprise a tobacco-containing material containing volatile tobacco flavour compounds, which are released from the substrate upon heating. The aerosol-forming substrate may comprise a non-tobacco material. The aerosol-forming substrate may further comprise an aerosol former. Examples of suitable aerosol formers are glycerin and propylene glycol.

As used herein, the term “mouthpiece” refers to a portion of an aerosol-generating article, an aerosol-generating device or an aerosol-generating system that is placed into a user's mouth in order to directly inhale an aerosol.

As used herein, the term “susceptor” refers to an element comprising a material that is capable of converting the energy of a magnetic field into heat. When a susceptor is located in an alternating magnetic field, the susceptor is heated. Heating of the susceptor may be the result of at least one of hysteresis losses and eddy currents induced in the susceptor, depending on the electrical and magnetic properties of the susceptor material.

As used herein, the term “inductively couple” refers to the heating of a susceptor when penetrated by an alternating magnetic field. The heating may be caused by the generation of eddy currents in the susceptor. The heating may be caused by magnetic hysteresis losses.

As used herein, the term “duty cycle” of the pulses of electrical current means the percentage of the ratio of pulse duration, or pulse width to the total period over which the pulses of current are supplied.

As used herein, the term “puff” means the action of a user drawing an aerosol into their body through their mouth or nose.

The invention is defined in the claims. However, below there is provided a non-exhaustive list of non-limiting examples. Any one or more of the features of these examples may be combined with any one or more features of another example, embodiment, or aspect described herein.

### Claims

Ex1. An induction heated aerosol-generating system comprising
an inductive heating arrangement having an inductor and a susceptor;
a power source for supplying power to the inductive heating arrangement; and
a controller configured to control power supplied from the power source to the inductive heating arrangement, and to monitor an electrical control parameter,
in which the controller is configured to operate the aerosol-generating system in a plurality of operational modes, the plurality of operational modes including at least;
a calibration mode, to determine a target value of the electrical control parameter;
a heating mode, in which power is supplied to the inductor to maintain the susceptor at an operational temperature, the operational temperature being maintained by control of power supplied to the inductor with reference to the target value of the electrical control parameter;
a re-calibration mode, to periodically or intermittently re-determine the target value of the electrical control parameter; and
a safety mode, to adjust the power provided to the inductive heating arrangement in response to one or more predetermined criteria being met.

Ex2. An aerosol-generating system according to example Ex1 in which the plurality of operational modes further includes a pre-heating mode, to raise the temperature of the susceptor to a predetermined temperature prior to operating in a different operational mode, for example the calibration mode or the heating mode.

Ex3. An aerosol-generating system according to any preceding example in which at least a portion of the susceptor is configured to undergo a reversible phase transition when heated or cooled through a predetermined temperature range.

Ex3a. An aerosol-generating system according to example Ex3 in which the controller is configured to identify upper and lower boundary values of the electrical control parameter associated with upper and lower boundaries of the phase transition.

Ex3b. An aerosol-generating system according to example Ex3a in which the target value of the electrical control parameter is set to a value between the upper and lower boundary values.

Ex4. An aerosol-generating system according to example Ex3, Ex3a, or Ex3b in which, during the calibration mode, the controller is configured to perform steps of; heating the susceptor through the predetermined temperature range, allowing the susceptor to cool through the predetermined temperature range, monitoring the electrical control parameter, identifying upper and lower boundary values of the electrical control parameter associated with upper and lower boundaries of the phase transition, and determining the target value of the electrical control parameter.

Ex5. An aerosol-generating system according to any of examples Ex3 to Ex4 in which, during the calibration mode, the controller is configured to perform steps of; heating the susceptor, monitoring the electrical control parameter while heating the susceptor, identifying upper and lower boundary values of the electrical control parameter associated with upper and lower boundaries of the phase transition, allowing the susceptor to cool through the predetermined temperature range, and monitoring the electrical control parameter while allowing the susceptor to cool, and determining the target value of the electrical control parameter.

Ex6. An aerosol-generating system according to any preceding example in which the step of heating the susceptor involves supplying power to the inductive heating arrangement.

Ex7. An aerosol-generating system according to any of examples Ex4 to Ex6 in which the power supplied to heat the susceptor during the calibration mode is supplied at a duty cycle of greater than 80%, for example greater than 90%, for example 100%.

Ex8. An aerosol-generating system according to any of examples Ex4 to Ex7 in which the step of allowing the susceptor to cool involves supplying power to the inductive heating arrangement at a reduced duty cycle, and monitoring the electrical control parameter.

Ex9. An aerosol-generating system according to any of examples Ex4 to Ex8 in which the step of allowing the susceptor to cool involves supplying power to the inductive heating arrangement as pulses of energy, for example pulses of current, for example pulses of energy having a duty cycle of less than 10%, for example less than 2% or less than 1%, and monitoring values of the electrical control parameter during each of the pulses.

Ex10. An aerosol-generating system according to any preceding example, in which the susceptor is located and/or locatable within an alternating electromagnetic field generated by the inductor.

Ex11. An aerosol-generating system according to any preceding example, the susceptor being configured to undergo a reversible phase transition when heated through a predetermined temperature range, a phase transition start point and a phase transition end point being identifiable by changes in the value of the electrical control parameter as the susceptor is heated through a predetermined temperature range, for example when the susceptor is heated in accordance with a calibration protocol during the calibration mode.

Ex12. An aerosol-generating system according to example Ex11 in which the target value of the electrical control parameter is determined to be between values of the electrical control parameter at the phase transition start point and the phase transition end point.

Ex13. An aerosol-generating system according to any of examples Ex3 to Ex12 in which the inductive heating arrangement exhibits a reversal in apparent resistance while undergoing the phase transition.

Ex14. An aerosol-generating system according to any of examples Ex3 to Ex13 in which the inductive heating arrangement exhibits a reversal in apparent conductance while undergoing the phase transition.

Ex15. An aerosol-generating system according to any examples Ex3 to Ex14 in which the apparent resistance of the inductive heating system increases prior to onset of the phase transition, decreases on heating through the phase transition, and increases on heating beyond the end of the phase transition.

Ex16. An aerosol-generating system according to any examples Ex3 to Ex15 in which the apparent conductance of the inductive heating system decreases prior to onset of the phase transition, increases on heating through the phase transition, and decreases on heating beyond the end of the phase transition.

Ex17. An aerosol-generating system according to any preceding example, in which the electrical control parameter is indicative of temperature of the susceptor, and/or indicative of a material property of the susceptor that varies as a function of temperature, and/or in which the electrical control parameter is a parameter that varies as a function of temperature of the susceptor.

Ex18. An aerosol-generating system according to any preceding example in which the electrical control parameter is a parameter selected from the list consisting of; electrical resistance of the susceptor, apparent electrical resistance of the inductive heating arrangement, electrical conductance of the susceptor, apparent electrical conductance of the inductive heating arrangement, current supplied to the inductive heating arrangement, and power supplied to the inductive heating arrangement.

Ex19. An aerosol-generating system according to any preceding example in which the controller is configured to monitor at least one power parameter representative of power supplied to the inductive heating arrangement during operation.

Ex20. An aerosol-generating system according to example Ex19 in which the at least one power parameter is used as the electrical control parameter, or in which the at least one power parameter is used to derive the electrical control parameter.

Ex21. An aerosol-generating system according to examples Ex19 or Ex20 in which the at least one power parameter is, or comprises, current supplied to the inductive heating arrangement during operation.

Ex22. An aerosol-generating system according to any of examples Ex19 to Ex21 in which in which the at least one power parameter is, or comprises is, or comprises, voltage across the inductive heating arrangement during operation.

Ex23. An aerosol-generating system according to any preceding example in which the system comprises an aerosol-generating article and an aerosol-generating device configured to receive the aerosol-generating article.

Ex24. An aerosol-generating system according to example Ex23 in which the aerosol-generating article comprises an aerosol-forming substrate and the susceptor is arranged in thermal communication with the aerosol-forming substrate.

Ex25. An aerosol-generating system according to example Ex23 or Ex24 in which the aerosol-generating article is a disposable article.

Ex26. An aerosol-generating system according to any of examples Ex23 to Ex25 in which the aerosol-generating device comprises the inductor, the controller, and a power supply for supplying power to the controller.

Ex27. An aerosol-generating system according to example Ex26 in which the aerosol-generating device further comprises a DC/AC convertor to convert direct current supplied by the power source to alternating current for supplying the inductor.

Ex28. An aerosol-generating system according to any preceding example comprising an aerosol-generating device configured to inductively heat an aerosol-forming substrate to generate an inhalable aerosol during a usage session.

Ex29. An aerosol-generating system according to any of examples Ex23 to Ex28 in which the aerosol-generating device is further configured to detect when an aerosol-generating article has been received in the aerosol-generating device.

Ex30. An aerosol-generating system according to example Ex29 in which the aerosol-generating device is further configured to determine whether the aerosol-generating article received in the aerosol-generating device is an article configured for use with the aerosol-generating device, preferably in which operation of the aerosol-generating device to heat the aerosol-generating article is prevented if the detected article is not configured for use with the aerosol-generating device.

Ex31. An aerosol-generating system according to any of examples Ex3 to Ex30 in which the phase transition is a magnetic phase transition or a crystallographic phase transition.

Ex32. An aerosol-generating system according to example Ex31 in which the phase transition is a ferro-magnetic/paramagnetic phase transition, or a ferri-magnetic/paramagnetic phase transition, or an antiferro-magnetic/paramagnetic phase transition.

Ex33. An aerosol-generating system according to any preceding example in which the susceptor comprises a first material that does not undergo a reversible phase transition on heating through a predetermined temperature range and a second material that does undergo a reversible phase transition when heated through the predetermined temperature range, preferably in which the predetermined temperature range is between 100° C. and 500°, for example between 200° C. and 400°.

Ex34. An aerosol-generating system according to example Ex33 in which the first material comprises greater than 50% by volume of the susceptor, preferably greater than 60% by volume, or greater than 70% by volume, or greater than 80% by volume, or greater than 90% by volume, or greater than 95% by volume.

Ex35. An aerosol-generating system according to example Ex33 or Ex34 in which the first material is an iron based alloy, for example a stainless steel.

Ex36. An aerosol-generating system according to any of examples Ex33 to Ex35 in which the second material is nickel or a nickel based alloy.

Ex37. An aerosol-generating system according to any preceding example in which the susceptor is formed as a unitary component, for example as an elongated pin, blade, wire, or strip, or as a sheet or mesh.

Ex38. An aerosol-generating system according to any preceding example in which the susceptor is an elongated susceptor, having a length dimension greater than a width dimension or a thickness dimension.

Ex39. An aerosol-generating system according to any preceding example in which the susceptor has a rectangular transverse cross-section, or a circular transverse cross-section.

Ex40. An aerosol-generating system according to any preceding example in which the susceptor has a length of between 8 mm and 100 mm, for example between 10 mm and 30 mm, for example between 12 mm and 20 mm.

Ex41. An aerosol-generating system according to any preceding example in which the susceptor has a width of between 2 mm and 6 mm, for example between 3 mm and 5 mm, for example between 3.5 mm and 4.5 mm.

Ex42. An aerosol-generating system according to any preceding example in which the susceptor has a thickness of between 0.1 mm and 2 mm, for example between 0.2 mm and 1.5 mm, for example between 0.4 mm and 1 mm.

Ex43. An aerosol-generating system according to any preceding example in which the susceptor is formed from a plurality of discrete components, for example from more than one elongated pins, blades, wires, or strips, more than one sheets or meshes, or more than one particle, for example the susceptor may be formed from a plurality of particles disposed in thermal contact with, or within, the aerosol-forming substrate.

Ex44. An aerosol-generating system according to any preceding example in which the power supply is a DC power supply, for example a battery located within the aerosol-generating device, the aerosol-generating device further comprising a DC to AC convertor, for example a DC to AC inverter, to supply AC power to the inductor.

Ex45. An aerosol-generating system according to any of examples Ex3 to Ex44 in which apparent resistance of the inductive heating arrangement exhibits a positive relationship with temperature immediately below the lower boundary of the phase transition and immediately above the upper boundary of the phase transition, and a negative relationship with temperature between the upper and lower boundaries of the phase transition.

Ex46. An aerosol-generating system according to any of examples Ex3 to Ex44 in which apparent conductance of the inductive heating arrangement exhibits a negative relationship with temperature immediately below the lower boundary of the phase transition and immediately above the upper boundary of the phase transition, and a positive relationship with temperature between the upper and lower boundaries of the phase transition.

Ex47. An aerosol-generating system according to any of examples Ex3 to Ex46 in which the operational temperature during the heating mode is a temperature upper and lower boundaries of the phase transition, that is, at a temperature between the phase transition starting and the phase transition ending.

Ex48. An aerosol-generating system according to any preceding example in which the heating mode is configured to maintain the temperature of the susceptor in accordance with a predetermined temperature profile.

Ex49. An aerosol-generating system according to any preceding example in which the power supplied to the inductor during the heating mode is supplied as pulses of power, for example pulses of electrical current, the temperature of the susceptor being controlled by varying the duty cycle of the inductor.

Ex50. An aerosol-generating system according to example Ex49 in which the controller is configured to control the temperature of the susceptor during the heating mode with reference to a target value of apparent resistance of the inductive heating arrangement, the target value of apparent resistance being determined during the calibration mode or during the re-calibration mode.

Ex51. An aerosol-generating system according to example Ex49 in which the controller is configured to control the temperature of the susceptor during the heating mode with reference to a target value of apparent conductance of the inductive heating arrangement, the target value of apparent conductance being determined during the calibration mode or during the re-calibration mode.

Ex52. An aerosol-generating system according to any of examples Ex3 to Ex51 in which the electrical control parameter is monitored during the heating mode to verify that a value of the electrical control parameter is between upper and lower boundary values of the electrical control parameter associated with upper and lower boundaries of the phase transition, and in which the device enters a safety mode if this cannot be verified.

Ex53. An aerosol-generating system according to any of examples Ex3 to Ex52 in which a response of the electrical control parameter to power supplied to the inductive heating arrangement, for example pulses of power supplied to the inductive heating arrangement, is monitored during the heating mode to verify that the susceptor is within an operational temperature range, and in which the device enters a safety mode if this cannot be verified.

Ex54. An aerosol-generating system according to any preceding example in which the safety mode involves a reduction in power supplied to the inductive heating arrangement, for example a reduction in the duty cycle supplied to the inductor, for a sufficient period of time to allow the susceptor to cool, for example cool to a temperature below the lower boundary of the phase transition.

Ex55. An aerosol-generating system according to any preceding example in which the aerosol-generating device comprises a puff sensor to determine the user puff, for example an airflow sensor, or a temperature sensor such as a thermistor mounted within an air flow path of the aerosol-generating device.

Ex56. An aerosol-generating system according to example Ex55 in which the heating mode comprises a non-puff heating regime and a puff heating regime, in which the controller is configured to operate according to the puff heating regime when it is detected that a user is taking a puff during the heating mode, and to operate according to the non-puff heating regime when it is not detected that a user is taking a puff during the heating mode.

Ex57. An aerosol-generating device according to example Ex56 in which the controller applies a limit to the power supplied to the inductive heating arrangement during the puff heating regime, for example by limiting the duty cycle to 50% of maximum duty cycle, or 60% of maximum duty cycle, or 70% of maximum duty cycle, or 80% of maximum duty cycle.

Ex58. An aerosol-generating device according to any of examples Ex55 to Ex57 in which a calibration mode or a recalibration mode is terminated if it is determined that a user takes a puff during operation under the calibration mode or the recalibration mode.

Ex59. An aerosol-generating device according to any of examples Ex55 to Ex58 in the controller prevents or delays instigation of the recalibration mode if it is determined that a user is taking a puff.

Ex60. An aerosol-generating system according to any preceding example comprising a temperature sensor located outside an airflow path in order to monitor temperature, for example temperature of an aerosol-generating device, for example a sensor such as a thermocouple or thermistor mounted on a PCB of the aerosol-generating device, or a thermocouple or thermistor mounted within a substrate receiving cavity of the aerosol-generating device.

Ex61. An aerosol-generating system according to example Ex60 in which the device enters the safety mode if the temperature of a portion of the device is determined to be out of a predetermined range, or in which operation is terminated if the temperature of a portion of the device is determined to be out of a predetermined range.

Ex62. An aerosol-generating system according to any preceding example in which the controller is configured to interrupt the heating mode to perform a recalibration according to the re-calibration mode, preferably in which the heating mode is resumed if the recalibration is performed successfully.

Ex63. An aerosol-generating system according to any preceding example, wherein the re-calibration mode is engaged periodically based on one or more criteria of: a predetermined duration of time, a predetermined number of user puffs, a predetermined number of temperature steps, and a measured voltage of the power source.

Ex64. An aerosol-generating system according to any preceding example in which the one or more predetermined criteria of the safety mode, for example safety criteria or safety triggers, are criteria set relating to operational events or monitored operational parameters, and the controller is configured to engage the safety mode in response to one or more of the predetermined criteria being met.

Ex65. An aerosol-generating system according to example Ex64 in which at least one of the one or more predetermined criteria is that a temperature of electronic components of the aerosol-generating system exceeds a predetermined temperature, for example temperature of a PCB of the aerosol-generating system exceeds a predetermined temperature, for example a temperature in excess of 50° C., or 60° C., or 70° C., or 80° C., or 100° C., preferably in which temperature of the electronic components is monitored by a temperature sensor mounted on or near the electronic components.

Ex66. An aerosol-generating system according to example Ex64 or Ex65 in which at least one of the one or more predetermined criteria is that temperature of a substrate-receiving cavity or chamber of the aerosol-generating system exceeds a predetermined temperature, for example temperature of a heating chamber of an aerosol-generating device exceeds a predetermined temperature, for example a temperature in excess of 400° C., or 410° C., or 450° C., or 480° C., preferably in which temperature of the substrate-receiving cavity or chamber is monitored by a temperature sensor mounted within the substrate-receiving cavity or chamber.

Ex67. An aerosol-generating system according to any of examples Ex64 to Ex66 in which at least one of the one or more predetermined criteria is that temperature of the susceptor exceeds a maximum operating temperature, for example a temperature in excess of 400° C., or 410° C., or 450° C., or 480° C.

Ex68. An aerosol-generating system according to any of examples Ex64 to Ex67 in which at least one of the one or more predetermined criteria is that temperature of the susceptor exceeds a Curie temperature of a material component of the susceptor.

Ex69. An aerosol-generating system according to any of examples Ex64 to Ex68 in which at least one of the one or more predetermined criteria is that a response a response of the electrical control parameter to power supplied to the inductive heating arrangement during the heating mode does not meet a predetermined condition, for example in which apparent conductance of the inductive heating arrangement does not rise in response to power supplied during the heating mode.

Ex70. An aerosol-generating system according to any of examples Ex64 to Ex69 in which at least one of the one or more predetermined criteria is that voltage of the power source falls below a predetermined level.

Ex71. An aerosol-generating system according to any of examples Ex64 to Ex70 in which the temperature of the susceptor is reduced during the safety mode.

Ex72. An aerosol-generating system according to any of examples Ex64 to Ex71 in which the safety mode may comprise steps of reducing power supplied to the inductive heating arrangement, terminating power supplied to the inductive heating arrangement, initiating another one of the plurality of operational modes, for example a calibration mode or a re-calibration mode, and/or terminating a user session.

Ex73. An aerosol-generating system according to any preceding claim in which operating in the safety mode comprises an adjustment to the power provided to the inductive heating arrangement, for example an adjustment to the power provided to the inductive heating arrangement in response to one or more overheating or cooling events.

Ex74. An aerosol-generating system according to any preceding example, comprising an aerosol-generating article and an aerosol-generating device for receiving the aerosol-generating article to generate an aerosol,
in which the aerosol-generating device comprises;
an inductor coupleable to a power supply; and
a controller;
and in which the aerosol-generating article comprises;
an aerosol-forming substrate; and
a susceptor in thermal communication with the aerosol-forming substrate, at least a portion of the susceptor configured to undergo a reversible phase transition when heated or cooled through a predetermined temperature range;
in which the aerosol-generating device is configured to;
(a) operate in the calibration mode in which power is supplied to the inductor to generate an alternating magnetic field to heat the susceptor through the predetermined temperature range, an electrical control parameter being monitored to identify a start and end of the phase transition, the start of the phase transition being a transition start point and the end of the phase transition being a transition end point;
(b) operate in the heating mode in which power is supplied to the inductor to maintain the susceptor in an operational temperature range for generation of an aerosol from the aerosol-forming substrate, the operational temperature range being maintained by control of power supplied to the inductor with reference to at least one of the transition start point and the transition end point determined during the calibration mode, and/or with reference to a target value of the electrical control parameter determined during the calibration mode;
(c) operate in the recalibration mode at predetermined intervals in order to update values of the transition start point and the transition end point to be used on continuation of the heating mode, and/or to update the target value of the electrical control parameter; and
(d) to operate in the safety mode if one or more predetermined criteria for initiating the safety mode are met.

Ex75. An aerosol generating system according to any preceding example comprising: an aerosol-generating device and an aerosol-generating article;
wherein the aerosol-generating device comprises a power supply, a DC/AC converter, an inductor coil, and a controller;
wherein the aerosol-generating article comprises an aerosol-forming substrate and a susceptor element, the susceptor element being inductively coupled to the inductor coil in use, and configured to heat the aerosol-forming substrate;
wherein the controller is configured to:
operate in the calibration mode to calculate a range of conductance or resistance values associated with the susceptor element, corresponding to a desirable temperature range for the susceptor element based on measurements of a change in conductance or resistance associated with the susceptor element with increased power provided to the inductive heating arrangement;
operate in the heating mode to provide power to the inductive heating arrangement to maintain the conductance or resistance associated with the susceptor element at a target value within the range conductance or resistance values;
operate in the re-calibration mode to periodically or intermittently re-calculate the range of conductance or resistance corresponding to the desirable temperature range for the susceptor element based on measurements of a change in conductance or resistance with increased power provided to the inductive heating arrangement; and
operate in the safety mode to adjust the power provided to the inductive heating arrangement in response to one or more overheating or cooling events.

Ex76. An aerosol-generating system according to any preceding example in which the controller is programmed with instructions to implement any of the plurality of operational modes, for example in which the controller comprises a memory containing executable instructions to implement any of the plurality of operational modes.

Ex77. An aerosol-generating device configured to be used in an aerosol-generating system as defined in any preceding example.

Ex78. An aerosol-generating article configured to be used in an aerosol-generating system as defined in any of examples Ex1 to Ex76.

Ex79. A method of controlling an induction heated aerosol-generating system comprising an inductive heating arrangement having an inductor and a susceptor; the method comprising steps of;
operating the system in a calibration mode, to determine a target value of an electrical control parameter;
operating the system in a heating mode by supplying power to the inductive heating arrangement to maintain the susceptor at an operational temperature with reference to the target value of the electrical control parameter;
periodically or intermittently operating the system in a re-calibration mode, to re-determine the target value of the electrical control parameter; and
adjusting the power provided to the inductive heating arrangement in response to one or more predetermined safety criteria being met.

Ex80. A method according to example Ex79 in which at least a portion of the susceptor is configured to undergo a reversible phase transition, and the calibration mode includes the step of heating the susceptor through a predetermined temperature range to determine upper and lower boundaries of the phase transition, for example by heating the susceptor until the upper boundary of the phase transition is detected.

Ex81. A method according to example Ex80 comprising the step of identifying upper and lower boundary values of the electrical control parameter associated with the upper and lower boundaries of the phase transition.

Ex82. A method of controlling an induction heated aerosol-generating system according to any of examples Ex79 to Ex81, the system comprising an aerosol-generating article and an aerosol-generating device for receiving the aerosol-generating article to generate an aerosol,
in which the aerosol-generating device comprises;
an inductor coupleable to a power supply; and
a controller;
and in which the aerosol-generating article comprises;
an aerosol-forming substrate; and
a susceptor in thermal communication with the aerosol-forming substrate, at least a portion of the susceptor configured to undergo a reversible phase transition when heated or cooled through a predetermined temperature range;
in which the method comprises steps of;
(a) operating the device in a calibration mode in which power is supplied to the inductor to generate an alternating magnetic field to heat the susceptor through the predetermined temperature range, and monitoring a power supply parameter to identify a start and end of the phase transition of the susceptor, the start of the phase transition being a transition start point and the end of the phase transition being a transition end point;
(b) after the calibration mode has completed, operating in a heating mode in which power is supplied to the inductor to maintain the susceptor in an operational temperature range for generation of an aerosol from the aerosol-forming substrate, the predetermined thermal profile being maintained by control of power supplied to the inductor with reference to at least one of the transition start point and the transition end point determined during the calibration mode or to a target derived from at least one of the transition start point and the transition end point determined during the calibration mode;
(c) at predetermined intervals during progress of the heating mode, switching to a recalibration mode in order to update values of the transition start point and the transition end point to be used on continuation of the heating mode; and
(d) detecting one or more signals regarding predetermined safety criteria, and
(e) in response to the detected signals, initiating a safety mode in which power provided to the inductive heating arrangement is adjusted.

Ex83. A method according to any of examples Ex79 to Ex82 further comprising the step of detecting that an aerosol-generating article has been received in the aerosol-generating device.

Ex84. A method according to any of examples Ex79 to Ex83 further comprising the step of determining whether or not an aerosol-generating article received in the aerosol-generating device is an article configured for use with the aerosol-generating device, and preferably preventing operation of the aerosol-generating device to heat the aerosol-generating article if the detected article is not an article configured for use with the aerosol-generating device.

Ex85. A method according to any of examples Ex79 to Ex84 in which the heating mode involves the step of maintaining the temperature of the susceptor in accordance with a predetermined temperature profile within an operational temperature range.

Ex86. A method of controlling an aerosol generating system, the system comprising an inductive heating arrangement including a susceptor element and an inductor coil, and a power source for providing power to the inductive heating arrangement as pulses of electrical current, the method comprising:
calculating a range of conductance or resistance values associated with the susceptor element, corresponding to a desirable temperature range for the susceptor element based on measurements of a change in conductance or resistance associated with the susceptor element with increased power provided to the inductive heating arrangement;
providing power to the inductive heating arrangement to maintain the conductance or resistance associated with the susceptor element at a target value within the range conductance or resistance values;
periodically or intermittently re-calculating the range of conductance or resistance corresponding to the desirable temperature range for the susceptor element, based on measurements of a change in conductance or resistance with increased power provided to the inductive heating arrangement; and
adjusting the power provided to the inductive heating arrangement in response to one or more overheating or cooling events.

Ex87. A method according to example Ex86, wherein the step of calculating a range of conductance or resistance values associated with the susceptor element, corresponding to a desirable temperature range for the susceptor element, comprises detecting a range conductance values over which conductance increases with increasing susceptor temperature.

Ex88. A method according to example Ex86 or Ex87, wherein the step of calculating a range of conductance or resistance values associated with the susceptor element, corresponding to a desirable temperature range for the susceptor element, comprises operating in a first calibration mode in which maximum power is provided to the inductive heating arrangement until a maximum conductance value is reached.

Ex89. A method according to any of examples Ex86 to Ex88, wherein the step of calculating a range of conductance or resistance values associated with the susceptor element, corresponding to a desirable temperature range for the susceptor element, comprises operating in a second calibration mode in which power is provided to the inductive heating arrangement with a low duty cycle until a minimum conductance value is reached.

Ex90. A method according to any of examples Ex86 to Ex89, wherein the providing power to the inductive heating arrangement to maintain the conductance or resistance associated with the susceptor element at a target value comprises operating in a heating mode in which the duty cycle of pulses of current provided to the inductive heating arrangement is adjusted to adjust the conductance or resistance towards the target conductance or resistance.

Ex91. A method according to any of examples Ex86 to Ex90, wherein adjusting the power provided to the inductive heating arrangement in response to one or more overheating or cooling events comprises detecting a cooling event that might cool the susceptor element, determining a maximum duty cycle limit for the pulses of electrical current during the cooling event, and increasing the duty cycle of the pulses of electrical current to compensate for the cooling event to a duty cycle no greater than the maximum duty cycle limit.

Ex92. A method according to any of examples Ex86 to Ex91, wherein adjusting the power provided to the inductive heating arrangement in response to one or more overheating or cooling events comprises detecting an overheating event and reducing the duty cycle of the pulses of electrical current in response to the detected overheating event.

Ex93. A method according to any of examples Ex86 to Ex92, wherein the aerosol-generating system comprises an aerosol-generating device and an aerosol-generating article, the power source and inductor coil being part of the aerosol-generating device and the susceptor element being part of the aerosol-generating article.

Ex94. A method according to example Ex92 or Ex93, wherein the overheating event is an overheating of the device or an overheating of the susceptor.

Ex95. A method according to any of examples Ex86 to Ex94, wherein the power supply comprises a DC/AC converter, and wherein the conductance value or resistance value associated with the susceptor is determined from a DC supply voltage of the power source and from the DC current drawn from the power source.

Ex96. A method of controlling an aerosol-generating system as defined in any of examples Ex79 to Ex95 using an aerosol-generating system as defined in any of examples Ex1 to Ex76.

Examples will now be further described with reference to the figures in which:

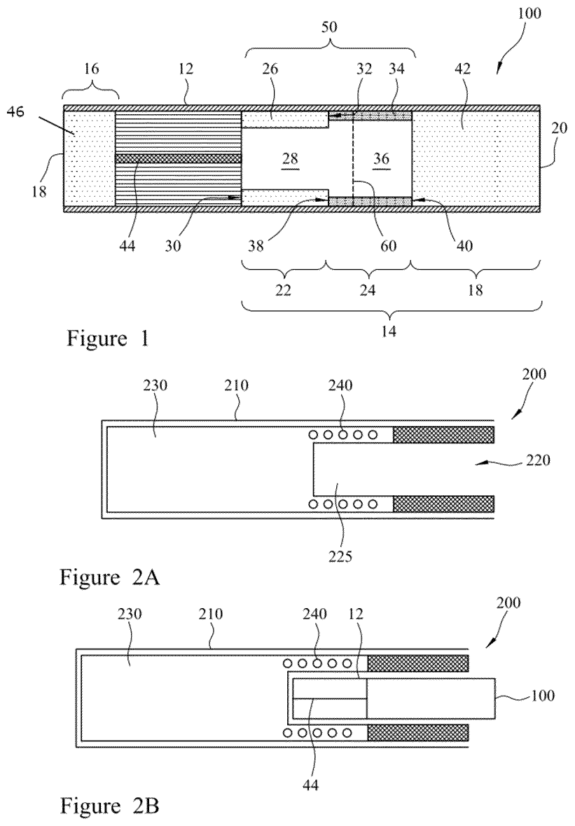

FIG. 1 shows a schematic cross-sectional illustration of an aerosol-generating article;

FIG. 2A shows a schematic cross-sectional illustration of an aerosol-generating device for use with the aerosol-generating article illustrated in FIG. 1;

FIG. 2B shows a schematic cross-sectional illustration of the aerosol-generating device in engagement with the aerosol-generating article illustrated in FIG. 1;

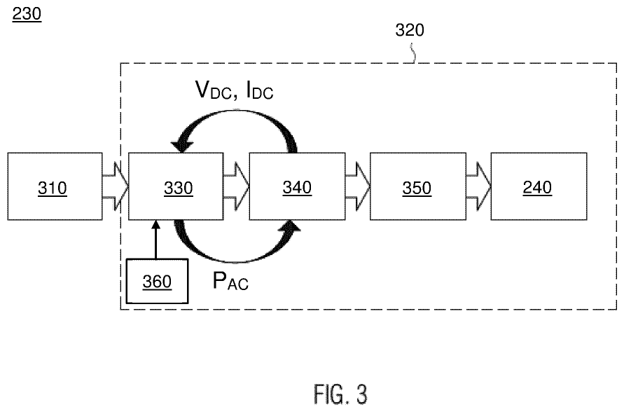

FIG. 3 is a block diagram showing an inductive heating device of the aerosol-generating device described in relation to FIG. 2;

FIG. 4 is a schematic diagram showing electronic components of the inductive heating device described in relation to FIG. 3;

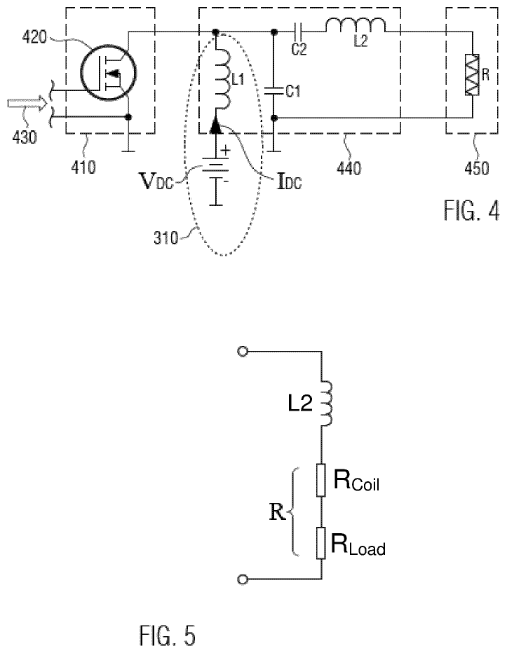

FIG. 5 is a schematic diagram on an inductor of an LC load network of the inductive heating device described in relation to FIG. 4;

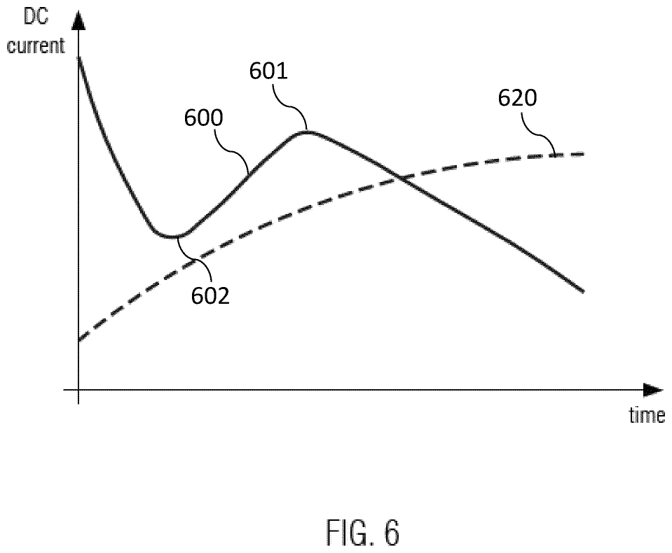

FIG. 6 is a graph of DC current vs. time illustrating the remotely detectable current changes that occur when a susceptor material undergoes a phase transition associated with its Curie point;

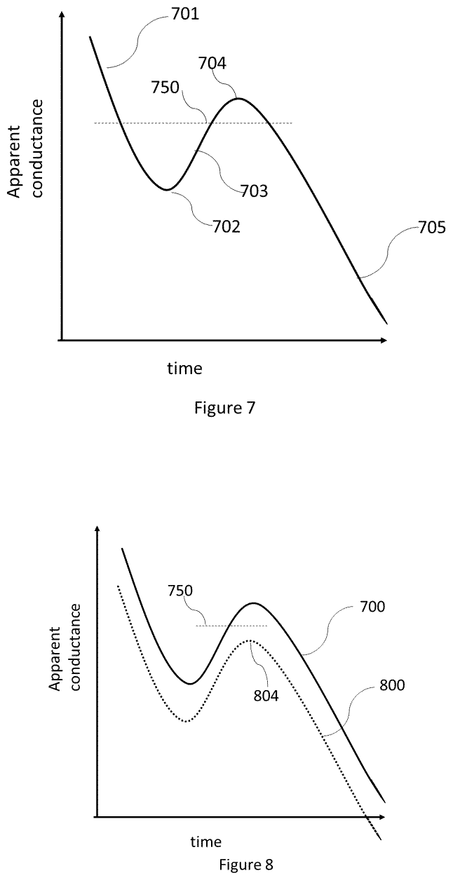

FIG. 7 is a graph of apparent conductance vs. time illustrating the remotely detectable current changes that occur when a susceptor material undergoes a phase transition associated with its Curie point;

FIG. 8 is a graph illustrating a shift in the apparent conductance curve when a susceptor moves position with respect to a conductor;

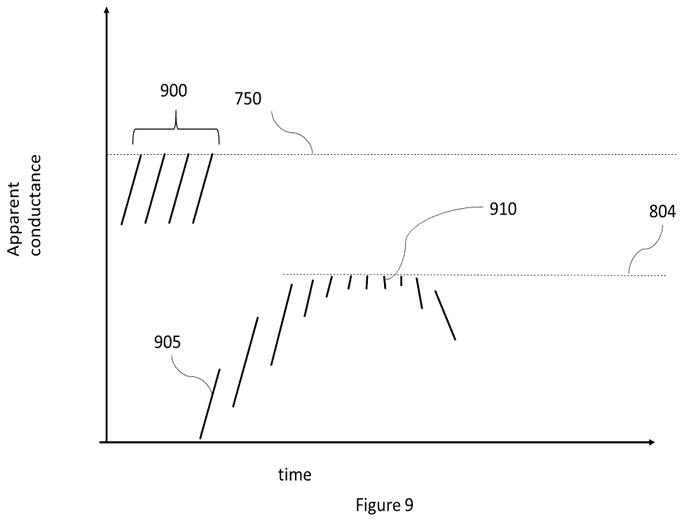

FIG. 9 is a diagram illustrating the effect that a shift in apparent conductance curve can have on the temperature control of the system; and

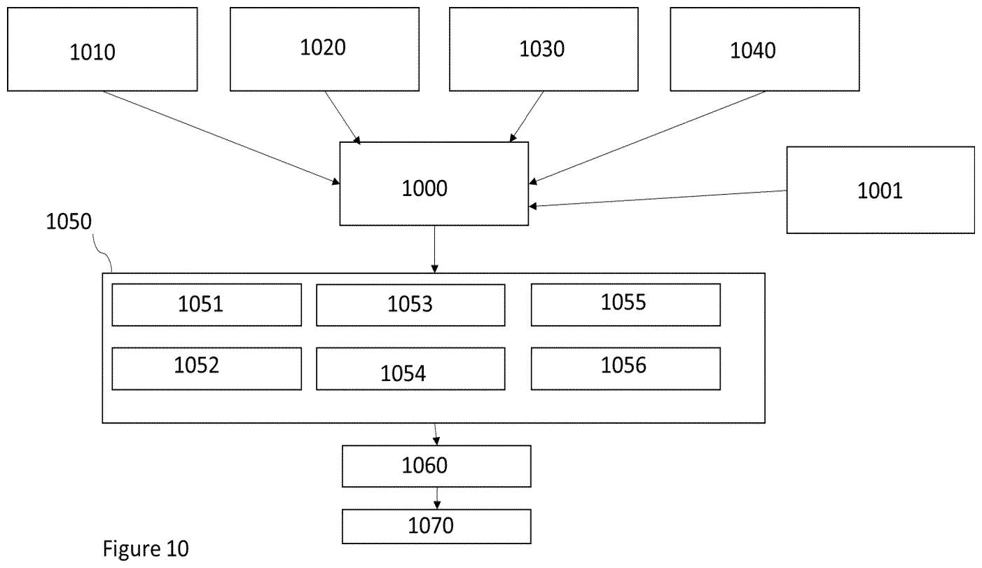

FIG. 10 is a schematic diagram illustrating control of an aerosol-generating system in a plurality of operational modes.

FIG. 1 illustrates an aerosol-generating article 100 for use in an aerosol-generating system. The aerosol-generating article 100 shown in FIG. 1 comprises a rod 12 of aerosol-generating substrate and a downstream section 14 at a location downstream of the rod 12 of aerosol-generating substrate. Further, the aerosol-generating article 100 comprises an upstream section 16 at a location upstream of the rod 12 of aerosol-generating substrate. Thus, the aerosol-generating article 100 extends from an upstream or distal end 18 to a downstream or mouth end 20.

The downstream section 14 comprises a support element 22 located immediately downstream of the rod 12 of aerosol-generating substrate, the support element 22 being in longitudinal alignment with the rod 12. In the embodiment of FIG. 1, the upstream end of the support element 22 abuts the downstream end of the rod 12 of aerosol-generating substrate. In addition, the downstream section 14 comprises an aerosol-cooling element 24 located immediately downstream of the support element 22, the aerosol-cooling element 24 being in longitudinal alignment with the rod 12 and the support element 22. In the embodiment of FIG. 1, the upstream end of the aerosol-cooling element 24 abuts the downstream end of the support element 22.

The support element 22 and the aerosol-cooling element 24 together define an intermediate hollow section 50 of the aerosol-generating article 100. As a whole, the intermediate hollow section 50 does not substantially contribute to the overall RTD of the aerosol-generating article.

The support element 22 comprises a first hollow tubular segment 26. The first hollow tubular segment 26 is provided in the form of a hollow cylindrical tube made of cellulose acetate. The first hollow tubular segment 26 defines an internal cavity 28 that extends all the way from an upstream end 30 of the first hollow tubular segment to a downstream end 32 of the first hollow tubular segment 26. The internal cavity 28 is substantially empty, and so substantially unrestricted airflow is enabled along the internal cavity 28.

The first hollow tubular segment 26 has a length of about 8 millimetres, an external diameter of about 7.25 millimetres, and an internal diameter (DFTS) of about 1.9 millimetres. Thus, a thickness of a peripheral wall of the first hollow tubular segment 26 is about 2.67 millimetres.

The aerosol-cooling element 24 comprises a second hollow tubular segment 34. The second hollow tubular segment 34 is provided in the form of a hollow cylindrical tube made of cellulose acetate. The second hollow tubular segment 34 defines an internal cavity 36 that extends all the way from an upstream end 38 of the second hollow tubular segment to a downstream end 40 of the second hollow tubular segment 34. The internal cavity 36 is substantially empty, and so substantially unrestricted airflow is enabled along the internal cavity 36.

The second hollow tubular segment 34 has a length of about 8 millimetres, an external diameter of about 7.25 millimetres, and an internal diameter (D_{STS}) of about 3.25 millimetres. Thus, a thickness of a peripheral wall of the second hollow tubular segment 34 is about 2 millimetres.

The aerosol-generating article 100 comprises a ventilation zone 60 provided at a location along the second hollow tubular segment 34. In more detail, the ventilation zone is provided at about 2 millimetres from the upstream end of the second hollow tubular segment 34. A ventilation level of the aerosol-generating article 100 is about 25 percent.

In the embodiment of FIG. 1, the downstream section 14 further comprises a mouthpiece element 42 at a location downstream of the intermediate hollow section 50. In more detail, the mouthpiece element 42 is positioned immediately downstream of the aerosol-cooling element 24. As shown in the drawing of FIG. 1, an upstream end of the mouthpiece element 42 abuts the downstream end 40 of the aerosol-cooling element 18.

The mouthpiece element 42 is provided in the form of a cylindrical plug of low-density cellulose acetate. The mouthpiece element 42 has a length of about 12 millimetres and an external diameter of about 7.25 millimetres.

The rod 12 comprises an aerosol-generating substrate of one of the types described above. The rod 12 of aerosol-generating substrate has an external diameter of about 7.25 millimetres and a length of about 12 millimetres.

The aerosol-generating article 100 further comprises an elongate susceptor element 44 within the rod 12 of aerosol-generating substrate. In more detail, the susceptor element 44 is arranged substantially longitudinally within the aerosol-generating substrate, such as to be approximately parallel to the longitudinal direction of the rod 12. As shown in the drawing of FIG. 1, the susceptor element 44 is positioned in a radially central position within the rod and extends effectively along the longitudinal axis of the rod 12.

The susceptor element 44 extends all the way from an upstream end to a downstream end of the rod 12. In effect, the susceptor element 44 has substantially the same length as the rod 12 of aerosol-generating substrate.

In the embodiment of FIG. 1, the susceptor element 44 is provided in the form of a strip and has a length of about 12 millimetres, a thickness of about 60 micrometres, and a width of about 4 millimetres. The upstream section 16 comprises an upstream element 46 located immediately upstream of the rod 12 of aerosol-generating substrate, the upstream element 46 being in longitudinal alignment with the rod 12. In the embodiment of FIG. 1, the downstream end of the upstream element 46 abuts the upstream end of the rod 12 of aerosol-generating substrate. This advantageously prevents the susceptor element 44 from being dislodged. Further, this ensures that the consumer cannot accidentally contact the heated susceptor element 44 after use.

The upstream element 46 is provided in the form of a cylindrical plug of cellulose acetate circumscribed by a stiff wrapper. The upstream element 46 has a length of about 5 millimetres.

The susceptor 44 comprises at least two different materials. The susceptor 44 comprises at least two layers: a first layer of a first susceptor material disposed in physical contact with a second layer of a second susceptor material. The first susceptor material and the second susceptor material may each be materials that undergo a Curie transition and, therefore, may each have a Curie temperature. In this case, the Curie temperature of the second susceptor material is lower than the Curie temperature of the first susceptor material. The first material may not undergo a Curie transition and may not have a Curie temperature. The first susceptor material may be aluminum, iron or stainless steel. The second susceptor material may be nickel or a nickel alloy. The susceptor 44 may be formed by electroplating at least one patch of the second susceptor material onto a strip of the first susceptor material. The susceptor may be formed by cladding a strip of the second susceptor material to a strip of the first susceptor material.

In use, air is drawn through the aerosol-generating article 100 by a user from the distal end 18 to the mouth end 20. The distal end 18 of the aerosol-generating article 100 may also be described as the upstream end of the aerosol-generating article 100 and the mouth end 20 of the aerosol-generating article 100 may also be described as the downstream end of the aerosol-generating article 100. Elements of the aerosol-generating article 100 located between the mouth end 20 and the distal end 18 can be described as being upstream of the mouth end 20 or, alternatively, downstream of the distal end 18. The aerosol-forming substrate 12 is located at the distal or upstream end 18 of the aerosol-generating article 100.

The aerosol-generating article 100 illustrated in FIG. 1 is designed to engage with an aerosol-generating device of the aerosol-generating system, such as the aerosol-generating device 200 illustrated in FIG. 2A, for producing an aerosol. The aerosol-generating device 200 comprises a housing 210 having a cavity 220 configured to receive the aerosol-generating article 100. The aerosol-generating device 200 further comprises an inductive heating device 230 configured to heat an aerosol-generating article 100 for producing an aerosol. FIG. 2B illustrates the aerosol-generating device 200 when the aerosol-generating article 100 is inserted into the cavity 220.

The inductive heating device 230 is illustrated as a block diagram in FIG. 3. The inductive heating device 230 comprises a DC power source 310 and a heating arrangement 320 (also referred to as power supply electronics). The heating arrangement comprises a controller 330, a DC/AC converter 340, a matching network 350 and an inductor 240.

The DC power source 310 is configured to provide DC power to the heating arrangement 320. Specifically, the DC power source 310 is configured to provide a DC supply voltage (V_{DC}) and a DC current (I_{DC}) to the DC/AC converter 340. Preferably, the power source 310 is a battery, such as a lithium ion battery. As an alternative, the power source 310 may be another form of charge storage device such as a capacitor. The power source 310 may require recharging. For example, the power source 310 may have sufficient capacity to allow for the continuous generation of aerosol for a period of around six minutes or for a period that is a multiple of six minutes. In another example, the power source 310 may have sufficient capacity to allow for a predetermined number of puffs or discrete activations of the heating arrangement.

The DC/AC converter 340 is configured to supply the inductor 240 with a high frequency alternating current. As used herein, the term “high frequency alternating current” means an alternating current having a frequency of between about 500 kilohertz and about 30 megahertz. The high frequency alternating current may have a frequency of between about 1 megahertz and about 30 megahertz, such as between about 1 megahertz and about 10 megahertz, or such as between about 5 megahertz and about 8 megahertz.

FIG. 4 schematically illustrates the electrical components of the inductive heating device 230, in particular the DC/AC converter 340. The DC/AC converter 340 preferably comprises a Class-E power amplifier. The Class-E power amplifier comprises a transistor switch 410 comprising a Field Effect Transistor 420, for example a Metal-Oxide-Semiconductor Field Effect Transistor, a transistor switch supply circuit indicated by the arrow 430 for supplying a switching signal (gate-source voltage) to the Field Effect Transistor 420, and an LC load network 440 comprising a shunt capacitor C1 and a series connection of a capacitor C2 and inductor L2, corresponding to inductor 240. In addition, the DC power source 310, comprising a choke L1, is shown for supplying the DC supply voltage V_{DC}, with a DC current I_{DC} being drawn from the DC power source 310 during operation. The ohmic resistance R representing the total ohmic load 450, which is the sum of the ohmic resistance R_{coil} of the inductor L2 and the ohmic resistance R_{load} of the susceptor 44, is shown in more detail in FIG. 5.

Although the DC/AC converter 340 is illustrated as comprising a Class-E power amplifier, it is to be understood that the DC/AC converter 340 may use any suitable circuitry that converts DC current to AC current. For example, the DC/AC converter 340 may comprise a class-D power amplifier comprising two transistor switches. As another example, the DC/AC converter 340 may comprise a full bridge power inverter with four switching transistors acting in pairs.

Turning back to FIG. 3, the inductor 240 may receive the alternating current from the DC/AC converter 340 via a matching network 350 for optimum adaptation to the load, but the matching network 350 is not essential. The matching network 350 may comprise a small matching transformer. The matching network 350 may improve power transfer efficiency between the DC/AC converter 340 and the inductor 240.

As illustrated in FIG. 2A, the inductor 240 is located adjacent to the distal portion 225 of the cavity 220 of the aerosol-generating device 200. Accordingly, the high frequency alternating current supplied to the inductor 240 during operation of the aerosol-generating device 200 causes the inductor 240 to generate a high frequency alternating magnetic field within the distal portion 225 of the aerosol-generating device 200. The alternating magnetic field preferably has a frequency of between 1 and 30 megahertz, preferably between 2 and 10 megahertz, for example between 5 and 7 megahertz. As can be seen from FIG. 2B, when an aerosol-generating article 100 is inserted into the cavity 200, the aerosol-forming substrate 12 of the aerosol-generating article 100 is located adjacent to the inductor 240 so that the susceptor 44 of the aerosol-generating article 100 is located within this alternating magnetic field. When the alternating magnetic field penetrates the susceptor 44, the alternating magnetic field causes heating of the susceptor 44. For example, eddy currents are generated in the susceptor 44 which is heated as a result. Further heating is provided by magnetic hysteresis losses within the susceptor 44. The heated susceptor 44 heats the aerosol-forming substrate 12 of the aerosol-generating article 100 to a sufficient temperature to form an aerosol. The aerosol is drawn downstream through the aerosol-generating article 100 and inhaled by the user.

The controller 330 may be a microcontroller, preferably a programmable microcontroller. The controller 330 is programmed to regulate the supply of power from the DC power source 310 to the inductive heating arrangement 320 in order to control the temperature of the susceptor 44. The controller is programmed to regulate the supply of power in order to control the aerosol-generating system according to a plurality of different operational modes. The controller may receive an input from a puff sensor 360, and from one or more temperature sensors, as will be described.

FIG. 6 illustrates the relationship between the DC current I_{DC} drawn from the power source 310 over time as the temperature of the susceptor 44 (the temperature is indicated by the dashed line 620) increases. The DC current is shown as line 600. The DC current I_{DC} drawn from the power source 310 is measured at an input side of the DC/AC converter 340. For the purpose of this illustration, it may be assumed that the voltage V_{DC} of the power source 310 remains approximately constant. The inductor and the susceptor form part of an inductive heating arrangement. As the susceptor 44 is inductively heated, the apparent resistance of the inductive heating arrangement and the susceptor itself increases and, as conductance is the inverse of resistance, the apparent conductance of the inductive heating arrangement decreases. The increase in resistance is observed as a decrease in the DC current I_{DC} drawn from the power source 310, which at constant voltage decreases as the temperature of the susceptor 44 increases. The high frequency alternating magnetic field provided by the inductor 240 induces eddy currents in close proximity to the susceptor surface, an effect that is known as the skin effect. The resistance in the susceptor 44 depends in part on the electrical resistivity of the first susceptor material, the resistivity of the second susceptor material and in part on the depth of the skin layer in each material available for induced eddy currents, and the resistivity is in turn temperature dependent. As the second susceptor material reaches its Curie temperature, it loses its magnetic properties. This causes an increase in the skin layer available for eddy currents in the second susceptor material, which causes a decrease in the apparent resistance of the susceptor 44. The result is a temporary increase in the detected DC current I_{DC} when the skin depth of the second susceptor material begins to increase, the resistance begins to fall. This is seen as the valley 602 (the local minimum) in FIG. 6. The current continues to increase until the maximum skin depth is reached, which coincides with the point where the second susceptor material has lost its spontaneous magnetic properties. This point is called the Curie temperature and is seen as the hill 601 (the local maximum) in FIG. 6. At this point the second susceptor material has undergone a phase change from a ferro-magnetic or ferri-magnetic state to a paramagnetic state. At this point, the susceptor 44 is at a known temperature (the Curie temperature, which is an intrinsic material-specific temperature). If the inductor 240 continues to generate an alternating magnetic field (i.e. power to the DC/AC converter 340 is not interrupted) after the Curie temperature has been reached, the eddy currents generated in the susceptor 44 will run against the resistance of the susceptor 44, whereby Joule heating in the susceptor 44 will continue, and thereby the resistance will increase again (the resistance will have a polynomial dependence of the temperature, which for most metallic susceptor materials can be approximated to a third degree polynomial dependence for our purposes) and current will start falling again as long as the inductor 240 continues to provide power to the susceptor 44.

Therefore, as can be seen from FIG. 6, the apparent resistance of the susceptor 44 (and correspondingly the current I_{DC} drawn from the power source 310) may vary with the temperature of the susceptor 44 in a strictly monotonic relationship over certain ranges of temperature of the susceptor 44. The strictly monotonic relationship allows for an unambiguous determination of the temperature of the susceptor 44 from a determination of the apparent resistance or apparent conductance (1/R). This is because each determined value of the apparent resistance is representative of only one single value of the temperature, so that there is no ambiguity in the relationship. The monotonic relationship of the temperature of the susceptor 44 and the apparent resistance allows for the determination and control of the temperature of the susceptor 44 and thus for the determination and control of the temperature of the aerosol-forming substrate 12. The apparent resistance of the susceptor 44 can be remotely detected by monitoring at least the DC current I_{DC} drawn from the DC power source 310.

At least the DC current I_{DC} drawn from the power source 310 is monitored by the controller 330. Preferably, both the DC current I_{DC} drawn from the power source 310 and the DC supply voltage V_{DC} are monitored. The controller 330 regulates the supply of power provided to the heating arrangement 320 based on a conductance value or a resistance value, where conductance is defined as the ratio of the DC current I_{DC} to the DC supply voltage V_{DC} and resistance is defined as the ratio of the DC supply voltage V_{DC} to the DC current I_{DC}. The heating arrangement 320 may comprise a current sensor (not shown) to measure the DC current I_{DC}. The heating arrangement may optionally comprise a voltage sensor (not shown) to measure the DC supply voltage V_{DC}. The current sensor and the voltage sensor are located at an input side of the DC/AC converter 340. The DC current I_{DC} and optionally the DC supply voltage V_{DC} are provided by feedback channels to the controller 330 to control the further supply of AC power P_{AC} to the inductor 240.

The controller 330 may control the temperature of the susceptor 44 by maintaining an electrical control parameter, which may be the measured apparent conductance value or the measured apparent resistance value, at a target value corresponding to a target operating temperature of the susceptor 44. The controller 330 may use any suitable control loop to maintain the measured conductance value or the measured resistance value at the target value, for example by using a proportional-integral-derivative control loop.

In order to take advantage of the strictly monotonic relationship between the apparent resistance (or apparent conductance) of the susceptor 44 and the temperature of the susceptor 44, during user operation for producing an aerosol, the conductance value or the resistance value associated with the susceptor and measured at the input side of the DC/AC converter 340 is maintained between a first calibration value corresponding to a first calibration temperature and a second calibration value corresponding to a second calibration temperature. The second calibration temperature is the Curie temperature of the second susceptor material (the hill 601 in the current plot in FIG. 6). The first calibration temperature is a temperature greater than or equal to the temperature of the susceptor at which the skin depth of the second susceptor material begins to increase (leading to a temporary lowering of the resistance). Thus, the first calibration temperature is a temperature greater than or equal to the temperature at maximum permeability of the second susceptor material. The first calibration temperature is preferably at least 50 degrees Celsius lower than the second calibration temperature. At least the second calibration value may be determined by calibration of the susceptor 44, as will be described in more detail below. The first calibration value and the second calibration value may be stored as calibration values in a memory of the controller 330.

Since the conductance (resistance) will have a polynomial dependence on the temperature, the conductance (resistance) will behave in a nonlinear manner as a function of temperature. However, the first and second calibration values are chosen so that this dependence may be approximated as being linear between the first calibration value and the second calibration value because the difference between the first and the second calibration values is small, and the first and the second calibration values are in the upper part of the operational temperature range. Therefore, to adjust the temperature to a target operating temperature, the conductance is regulated according to the first calibration value and the second calibration value, through linear equations. For example, if the first and the second calibration values are conductance values, the target conductance value corresponding to the target operating temperature may be given by:

$${G}_{Target} = {G}_{L o w e r} + ( x \times Δ G )$$

where ΔG is the difference between the first conductance value and the second conductance value and χ is a percentage of ΔG.

The controller 330 may control the provision of power to the heating arrangement 320 by adjusting the duty cycle of the switching transistor 410 of the DC/AC converter 340. For example, during heating, the DC/AC converter 340 continuously generates alternating current that heats the susceptor 44, and simultaneously the DC supply voltage V_{DC} and the DC current I_{DC} may be measured, preferably every millisecond for a period of 100 milliseconds. If the conductance is monitored by the controller 330, when the conductance reaches or exceeds a value corresponding to the target operating temperature, the duty cycle of the switching transistor 410 is reduced. If the resistance is monitored by the controller 330, when the resistance reaches or goes below a value corresponding to the target operating temperature, the duty cycle of the switching transistor 410 is reduced. For example, the duty cycle of the switching transistor 410 may be reduced to about 9%. In other words, the switching transistor 410 may be switched to a mode in which it generates pulses only every 10 milliseconds for a duration of 1 millisecond. During this 1 millisecond on-state (conductive state) of the switching transistor 410, the values of the DC supply voltage V_{DC} and of the DC current I_{DC} are measured and the conductance is determined. As the conductance decreases (or the resistance increases) to indicate that the temperature of the susceptor 44 is below the target operating temperature, the gate of the transistor 410 is again supplied with the train of pulses at the chosen drive frequency for the system.

The power may be supplied by the controller 330 to the inductor 240 in the form of a series of successive pulses of electrical current. In particular, power may be supplied to the inductor 240 in a series of pulses, each separated by a time interval. The series of successive pulses may comprise two or more heating pulses and one or more probing pulses between successive heating pulses. The heating pulses have an intensity such as to heat the susceptor 44. The probing pulses are isolated power pulses having an intensity such not to heat the susceptor 44 but rather to obtain a feedback on the conductance value or resistance value and then on the evolution (decreasing) of the susceptor temperature. The controller 330 may control the power by controlling the duration of the time interval between successive heating pulses of power supplied by the DC power supply to the inductor 240. Additionally or alternatively, the controller 330 may control the power by controlling the length (in other words, the duration) of each of the successive heating pulses of power supplied by the DC power supply to the inductor 240.

The controller 330 is programmed to operate in a calibration mode to perform a calibration process in order to obtain the calibration values at which the conductance is measured at known temperatures of the susceptor 44. The known temperatures of the susceptor may be the first calibration temperature corresponding to the first calibration value and the second calibration temperature corresponding to the second calibration value. Preferably, the calibration mode is operated each time the user operates the aerosol-generating device 200, for example each time the user inserts an aerosol-generating article 100 into an aerosol-generating device 200.

During the calibration mode, the controller 330 controls the DC/AC converter 340 to continuously or continually supply power to the inductor 240 in order to heat the susceptor 44. The controller 330 monitors the conductance or resistance associated with the inductive heating arrangement or the susceptor 44 by measuring the current I_{DC} drawn by the power supply and, optionally the power supply voltage V_{DC}. As discussed above in relation to FIG. 6, as the susceptor 44 is heated, the measured current decreases until a first turning point 602 is reached and the current begins to increase. This first turning point or valley 602 corresponds to a local minimum conductance value (a local maximum resistance value). The controller 330 may record the local minimum value of conductance (or local maximum of resistance) as the first calibration value. The controller may record the value of conductance or resistance at a predetermined time after the minimum current has been reached as the first calibration value. The conductance or resistance may be determined based on the measured current I_{DC} and the measured voltage V_{DC}. Alternatively, it may be assumed that the power supply voltage V_{DC}, which is a known property of the power source 310, is approximately constant. The temperature of the susceptor 44 at the first calibration value is referred to as the first calibration temperature. Preferably, the first calibration temperature is between 150 degrees Celsius and 350 degrees Celsius. More preferably, when the aerosol-forming substrate 12 comprises tobacco, the first calibration temperature is 320 degrees Celsius. The first calibration temperature is at least 50 degrees Celsius lower than the second calibration temperature.

As the controller 330 continues to control the power provided by the DC/AC converter 340 to the inductor 240, the measured current increases until a second turning point 601 is reached and a maximum current is observed (corresponding to the Curie temperature of the second susceptor material) before the measured current begins to decrease. This turning point or hill 601 corresponds to a local maximum conductance value (a local minimum resistance value). The controller 330 records the local maximum value of the conductance (or local minimum of resistance) as the second calibration value. The temperature of the susceptor 44 at the second calibration value is referred to as the second calibration temperature. Preferably, the second calibration temperature is between 200 degrees Celsius and 400 degrees Celsius. When the maximum is detected, the controller 330 controls the DC/AC converter 340 to interrupt provision of power to the inductor 240, resulting in a cooling of the susceptor.

This calibration process of continuously heating the susceptor 44 to obtain the first calibration value and the second calibration value may be repeated at least once to improve reliability of the calibration.

In order to further improve the reliability of the calibration process, the controller 310 may be optionally programmed to operate in a pre-heating mode, to perform a pre-heating process before operating in the calibration mode. For example, if the aerosol-forming substrate 12 is particularly dry or in similar conditions, the calibration may be performed before heat has spread within the aerosol-forming substrate 12, reducing the reliability of the calibration values. If the aerosol-forming substrate 12 were humid, the susceptor 44 takes more time to reach the valley temperature (due to water content in the substrate 12).

During operation according to the pre-heating mode, the controller 330 is configured to continuously provide power to the inductor 240. As described above, the current starts decreasing with increasing susceptor 44 temperature until the minimum is reached. At this stage, the controller 330 is configured to wait for a predetermined period of time to allow the susceptor 44 to cool before continuing heating. The controller 330 therefore controls the DC/AC converter 340 to interrupt provision of power to the inductor 240. After the predetermined period of time, the controller 330 controls the DC/AC converter 340 to provide power until the minimum is reached. At this point, the controller controls the DC/AC converter 340 to interrupt provision of power to the inductor 240 again. The controller 330 again waits for the same predetermined period of time to allow the susceptor 44 to cool before continuing heating. This heating and cooling of the susceptor 44 is repeated for the predetermined duration of time of the pre-heating process. The predetermined duration of the pre-heating process is preferably 11 seconds. The predetermined combined durations of the pre-heating process followed by the calibration process is preferably 20 seconds.

If the aerosol-forming substrate 12 is dry, the first minimum of the pre-heating process is reached within the pre-determined period of time and the interruption of power will be repeated until the end of the predetermined time period. If the aerosol-forming substrate 12 is humid, the first minimum of the pre-heating process will be reached towards the end of the pre-determined time period. Therefore, performing the pre-heating process for a predetermined duration ensures that, whatever the physical condition of the substrate 12, the time is sufficient for the substrate 12 to reach the minimum temperature, in order to be ready to feed continuous power and reach the first maximum. This allows the calibration mode to be operated as early as possible, but still without risking that the substrate 12 would not have reached the valley beforehand.

Further, the aerosol-generating article 100 may be configured such that the minimum is always reached within the predetermined duration of the pre-heating process. If the minimum is not reached within the pre-determined duration of the pre-heating process, this may indicate that the aerosol-generating article 100 comprising the aerosol-forming substrate 12 is not suitable for use with the aerosol-generating device 200. For example, the aerosol-generating article 100 may comprise a different or lower-quality aerosol-forming substrate 12 than the aerosol-forming substrate 100 intended for use with the aerosol-generating device 200. As another example, the aerosol-generating article 100 may not be configured for use with the heating arrangement 320, for example if the aerosol-generating article 100 and the aerosol-generating device 200 are manufactured by different manufacturers. Thus, the controller 330 may be configured to generate a control signal to enter a safety mode or to cease operation of the aerosol-generating device 200.

The pre-heating mode may be performed in response to receiving a user input, for example user activation of the aerosol-generating device 200. Additionally or alternatively, the controller 330 may be configured to detect the presence of an aerosol-generating article 100 in the aerosol-generating device 200 and the pre-heating process may be performed in response to detecting the presence of the aerosol-generating article 100 within the cavity 220 of the aerosol-generating device 200.

Following implementation of the pre-heating mode and the calibration mode, the controller 330 switches control to a heating mode in which the controller controls the DC/AC converter 340 to maintain the conductance or resistance associated with the susceptor 44 at a target value. This may be referred to as the heating process or the operational heating mode. The target value may change over time in a continuous or step-wise manner but will always be between the maximum and minimum values determined during the calibration process.

The heating mode may be interrupted and the recalibration mode may be operated, so that a recalibration process may be performed, at set time intervals during the heating mode. This is done in order to verify or re-establish the maximum and minimum values, which may drift over a period of use of the device.

In order to maintain the conductance or resistance associated with the susceptor 44 at the target value during the heating mode, the controller 330 varies the duty cycle of the DC/AC converter 340. If the susceptor is cooled by an increased airflow past the susceptor, such as during a user puff on the system, the conductance associated with the susceptor will fall. The controller 330 will then increase the duty cycle of the pulses of current to increase the power provided to the inductor and thereby bring the conductance of the susceptor back towards the target value.

In order to prevent overheating of the device, the heating mode is configured to operate in a different regime when a user is determined to be taking a puff. Thus, the heating mode comprises a non-puff regime as described, and a puff regime implemented when a user puff is detected. Experiments have shown that, during an event that cools the susceptor, such as a user puff, the S-shaped curve shown in FIG. 6 undergoes a compression so that the local minimum of DC current 602 (or conductance) has a higher value and the local maximum of DC current 601 at the Curie temperature is reduced.

This flattening of the curve shown in FIG. 6 means that the normal control process might lead to overheating. For example, if a cooling event, such as a user puff, occurs when the target conductance is close to the local maximum conductance established during the calibration process, it may be that the target conductance is not actually achievable. In that circumstance there is a risk that the controller will continue to increase the duty cycle of the pulses of electrical current to the point that the susceptor is overheated, i.e. is heated to a temperature which provides an undesirable aerosol.

To reduce the possibility of overheating of the susceptor when a user takes a puff during heating mode operation, the controller operates in a puff regime, which may be termed a puff mode, or a puff heating mode. Thus, the controller is configured to introduce a duty cycle limit when a cooling event, such as a user puff, is detected during the heating mode. For example, during a steady state before a user puff, a 30% duty cycle may be needed to maintain the target conductance. When the susceptor is cooled the controller might need to increase the duty cycle to 50% to maintain the target conductance. However, the controller may introduce a duty cycle limit of less than 50% to prevent overheating. This means that the susceptor may not reach the target temperature during the puff, but preventing overheating is more important than preventing a marginal under heating.

In order to prevent overheating of the device or the susceptor during operation one or more safety modes or safety processes may be implemented.

One safety process, schematically illustrated with respect to FIGS. 7, 8, and 9, involves monitoring the response of the electrical control parameter to pulses of current supplied to the inductive heating arrangement, that is the response of apparent conductance to supplied current, to check that a predetermined condition is met. The predetermined condition is that the conductance values rise over the duration of each pulse during the operational heating mode. If this condition is not met then the controller implements a safety mode, which may be termed a recovery mode, in which the susceptor is allowed to cool and a recalibration is undertaken to determine an updated target value of the conductance.

FIG. 7 shows the response of a calculated apparent conductance of an inductive heating arrangement to continuous supply of power, for example as in a calibration mode as described above. It is noted that a calibration mode is unlikely to result in heating of the susceptor substantially beyond the maxima noted by reference numeral 704, as this may result in the susceptor overheating. The line 705 is continued beyond the maxima 704 in FIG. 7 for illustrative purposes. The article and device are as described above. On supplying current to the inductor, the temperature of the susceptor rises. As the temperature of the susceptor rises, its conductance initially falls 701. The susceptor includes a portion of material (such as a nickel alloy) that undergoes a phase transition, specifically a Curie transition from a ferromagnetic phase to a paramagnetic phase, at a particular temperature (for example within a temperature range of about 300-400° C.). As described above, the onset of this transition is detectable by a local minima 702 in conductance. As the temperature of the susceptor continues to rise with continued current supply, the phase transition proceeds and the conductance continues to rise 703. At the Curie temperature of the transitioning susceptor material the phase transition is complete. This is detectable by a local maxima 704 of conductance. The relationship of conductance to temperature now reverts to its original state, and conductance decreases with increasing temperature 705.

By operating in the calibration mode, values of apparent conductance can be matched with temperature for any particular inductive heating arrangement (i.e. that formed by a specific inductor/susceptor couple). Thus, because the Curie temperature is known, this temperature can be determined to be equal to the value of apparent conductance at the local maxima 704. The temperature of the susceptor can then be controlled with reference to a target value of the apparent conductance 750 set between the local minima 702 and the local maxima 704 of the calibrated conductance time curve.

It is notable that the target value of apparent conductance is set between the minima 702 and the maxima 701. In this region, the apparent conductance increases with increase in temperature. Either side of the phase transition, i.e. before the minima 702 or after the maxima 704 the apparent conductance decreases with temperature. It is also notable that while the target value of apparent conductance 750 equates to a target operating temperature while the susceptor is undergoing its phase transition (i.e. between the minima 702 and maxima 704), the s-shape of the curve means that the same value of apparent resistance also occurs at a lower temperature, and a higher temperature.

During the heating mode to generate an aerosol, current is supplied to the inductive heating arrangement as pulses of current, and these pulses are controlled with reference to a target value of the apparent conductance, as described above. To check that the temperature of the susceptor is being controlled correctly, the response of the apparent conductance to the pulses of current is determined. If the susceptor is being maintained at the correct temperature, the apparent conductance will rise as a response to a pulse of current. This confirms that the temperature of the susceptor is between the maxima and minima determined by the calibration and that by controlling with reference to the target value of apparent conductance, the desired operating temperature is being achieved. If the apparent conductance does not meet this predetermined criteria that it should rise in response to a pulse of current, then a fault may be assumed and the controller implements a recovery mode in which the susceptor is allowed to cool and a calibration mode is performed.

The curve illustrated in FIG. 7 is an example of the response of apparent conductance to a calibration mode. Such a mode may be carried out when an article is inserted into a device prior to generate an aerosol. A number of scenarios may occur which invalidate the calibration and potentially result in the temperature of the susceptor being maintained incorrectly.

For example, it may be that the article is incorrectly inserted into the device when the calibration is undertaken. Notwithstanding this, the device regulates the temperature normally at the conductance target value 750 determined by calibration. During use, however, the article may be further pushed into the device, thereby moving the susceptor relative to the inductor. This causes the S-curve to shift down from its initial calibrated value 700 to a new position 800, as illustrated in FIG. 8.

The problem is that the conductance target value 750 is now located above the maxima 804 of the new s-curve 800. As a result, the device attempts to control the supply of current with reference to the calibrated target value 750, but this target value cannot be reached due to the repositioning of the s-curve such that the new maxima 804 is the maximum conductance value which can be reached. The device continues heating in order to meet the calibrated conductance target 750, but eventually reaches the new maxima 804. After reaching the new maxima 804 the device continues the heating until it actually passes the maxima 804. After the maxima 804, the response of conductance to temperature is inverted, meaning that a power pulse triggers causes a decrease in apparent conductance.

The effect can be seen in FIG. 9. After the initial calibration, a target conductance 750 is set, between maxima 704 and minima 702 of the calibration curve. Initially, during a heating mode, pulses of current are supplied to the inductive heating arrangement and controlled with reference to the target conductance value 750. Such controlled pulses are seen in the group of pulses 900 in FIG. 9. The slope of these pulses can be seen to be positive, as the conductance increases over the duration of each pulse. After the article is moved in the device, the s-curve is displaced as discussed above. The result is that the first pulse of current after this anomalous movement 905 registers a lower apparent conductance. Conductance increases with subsequent pulses as the controller attempts to raise the conductance to the target level 750. However, the new maxima 804 is lower than the target value 750, which means that the pulses of current are not controlled. As the temperature of the susceptor increases, the response of the apparent conductance to supplied power changes, and the conductance starts to fall with each pulse 910. Without a safety mechanism the temperature may keep increasing as conductance falls. However, when the first pulse is detected that does not demonstrate an increase in conductance over its duration (for example pulse 910) the controller initiates the safety mode or recovery mode.

As described above, the controller of the system receives various inputs and signals, and controls the supply of power to the inductive heating arrangement according to a plurality of operational modes. This control is illustrated schematically for the aerosol-generating system described above in FIG. 10.

As illustrated in FIG. 10, the controller 1000 is configured to receive input signals from a user interface 1001, a voltage sensor 1010 determining voltage across the input side of the DC/AC convertor of the inductive heating arrangement, a current sensor 1020 determining DC current supplied to the inductive heating arrangement, a puff sensor 1030 for detecting a user puff, and a PCB temperature sensor 1040 for determining temperature of control electronics of the aerosol-generating device.

The controller processes the various input signals and determines which of a plurality of operational modes applies 1050. The controller then controls supply of power from the power source 1060 to the inductive heating arrangement 1070 to control the temperature of the susceptor according to one of the plurality of operational modes 1050.

In a specific example the operational modes are a pre-heating mode 1051, a calibration mode 1052, a heating mode: non-puff regime 1053, a heating mode: puff regime 1054, a re-calibration mode 1055, and a safety mode or recovery mode 1056.

As an example of operation, the controller 1000 may receive a signal from the user interface 1001 that a user has instigated a usage session to consume an aerosol-generating article. The controller sends signals to operate in the pre-heating mode 1051. Signals from the voltage sensor 1010 and the current sensor 1020 are received by the controller 1000 and a value for apparent conductance of the inductive heating arrangement 1070 is calculated. Values of the apparent conductance are monitored.

When the pre-heating mode 1051 has concluded, for example after a predetermined period of time, the controller sends signals to operate in the calibration mode 1052. The calibration mode proceeds, for example as described above, and a target value of the apparent conductance is determined.

When the calibration mode 1052 has concluded, for example when the target value of apparent conductance has been determined, the controller sends signals to operate in the heating mode: non-puff regime 1053. This heating mode applies when a user is not puffing on the device. The temperature of the susceptor is maintained at the operational temperature by supplying pulses of current to the inductive heating arrangement and controlling the power supplied with reference to the target value of conductance.

If during the heating mode: non-puff regime 1053 a signal is received from the puff sensor 1030 indicating that a user is taking a puff, the controller issues a signal to switch operational mode to heating mode: puff regime 1054. This mode is similar to the heating mode: non-puff regime, but with a limit on the duty cycle of power supplied to the inductive heating arrangement to prevent overheating. When the controller determines that a user is no longer taking a puff, a signal is issued to revert to the heating mode: non-puff regime 1053.

At periodic time intervals, or after a predetermined number of puffs have been recorded, the controller issues a signal to operate in the re-calibration mode 1055. The re-calibration mode verifies or re-determines the target value of conductance. If the re-calibration mode completes successfully, the controller issues a signal to revert to the heating mode: non-puff regime. If the recalibration mode does not complete successfully then there may be a fault and the controller issues a signal to operate according to the safety mode.

If the controller receives a signal indicating that the user is taking a puff, any switch to the re-calibration mode is delayed until the user has finished the puff. If the controller receives a signal indicating that the user is taking a puff during operation under the re-calibration mode, the re-calibration mode is terminated and operational mode switched to heating mode: puff regime.

A number of anomalies or fault states may occur during use of the aerosol-generating system. For example, the monitored value of conductance may indicate that the susceptor has overheated. In such a case the controller issues a signal to enter the safety mode 1056. In the safety mode the power supplied to the inductive heating arrangement is reduced or terminated for a period of time to allow the susceptor to cool. The safety mode may include a re-calibration or re-set prior to operation continuing in one of the other operational mode. If the anomaly or fault cannot be rectified by the recovery process operated during the recovery mode, operation is terminated.

A further example of a fault state may be that it is determined that the conductance is not increasing in response to pulses of current supplied during a heating mode. This may indicate that the susceptor is too hot or too cool, and the controller sends a signal to operate according to the safety mode.

A further example of a fault state may be that it is determined that the temperature of the PCB is greater than a predetermined maximum temperature. This may indicate that the susceptor is overheating and overheating the device, and the controller sends a signal to operate according to the safety mode.

A further example of a fault state may be that it is determined that the voltage of the power supply has decreased below a minimum operating voltage. This may indicate that the power supply has insufficient remaining charge to complete a usage session, and the controller sends a signal to operate according to the safety mode. In this case, it may be unlikely that operation can resume without the power supply being recharged.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-16. (canceled)

17. An induction heatable aerosol-generating system, comprising:
an inductive heating arrangement having an inductor and a susceptor;
a power source configured to supply power to the inductive heating arrangement; and
a controller configured to:
control power supplied from the power source to the inductive heating arrangement,
monitor an electrical control parameter, and
operate the induction heatable aerosol-generating system in a plurality of operational modes, the plurality of operational modes including at least:
a calibration mode, to determine a relationship between the electrical control parameter and a temperature of the susceptor and to determine a target value of the electrical control parameter,
a heating mode, in which power is supplied to the inductor to maintain the susceptor at an operational temperature, the operational temperature being maintained by control of power supplied to the inductor with reference to the target value of the electrical control parameter,
a re-calibration mode, to verify or modify the relationship between the electrical control parameter and the temperature of the susceptor and to periodically or intermittently re-determine the target value of the electrical control parameter, wherein the re-calibration mode is engaged periodically based on one or more criteria of: a predetermined duration of time, a predetermined number of user puffs, a predetermined number of temperature steps, and a measured voltage of the power source, and
a safety mode, to adjust the power provided to the inductive heating arrangement in response to one or more predetermined criteria being met.

18. The induction heatable aerosol-generating system according to claim 17, wherein the electrical control parameter is a parameter selected from the list consisting of: electrical resistance of the susceptor, apparent electrical resistance of the inductive heating arrangement, electrical conductance of the susceptor, apparent electrical conductance of the inductive heating arrangement, current supplied to the inductive heating arrangement, and power supplied to the inductive heating arrangement.

19. The induction heatable aerosol-generating system according to claim 17, wherein the heating mode is configured to maintain the temperature of the susceptor in accordance with a predetermined temperature profile.

20. The induction heatable aerosol-generating system according to claim 17, wherein the power supplied to the inductor during the heating mode is supplied as pulses of power, the temperature of the susceptor being controlled by varying the duty cycle of the inductor.

21. The induction heatable aerosol-generating system according to claim 20, wherein the controller is further configured to control the temperature of the susceptor during the heating mode with reference to a target value of apparent conductance of the inductive heating arrangement, the target value of apparent conductance being determined during the calibration mode or during the re-calibration mode.

22. The induction heatable aerosol-generating system according to claim 17, wherein the safety mode involves a reduction in power supplied to the inductive heating arrangement, for example a reduction in the duty cycle supplied to the inductor, for a sufficient period of time to allow the susceptor to cool.

23. The induction heatable aerosol-generating system according to claim 17, wherein the safety mode involves a reduction in the duty cycle supplied to the inductor, for a sufficient period of time to allow the susceptor to cool.

24. The induction heatable aerosol-generating system according to claim 17, further comprising a puff sensor configured to determine a user puff.

25. The induction heatable aerosol-generating system according to claim 24, wherein the puff sensor is an airflow sensor, or a temperature sensor such as a thermistor mounted within an air flow path of an aerosol-generating device.

26. The induction heatable aerosol-generating system according to claim 17,
wherein the heating mode comprises a non-puff heating regime and a puff heating regime,
wherein the controller is further configured to operate according to the puff heating regime when it is detected that a user is taking a puff during the heating mode, and to operate according to the non-puff heating regime when it is not detected that a user is taking a puff during the heating mode.

27. The induction heatable aerosol-generating system according to claim 17, wherein the controller is further configured to prevent or to delay a switch from operating according to the heating mode to operating according to the re-calibration mode if it is determined that a user is taking a puff.

28. The induction heatable aerosol-generating system according to claim 17, further comprising a temperature sensor located outside an airflow path to monitor a temperature of an aerosol-generating device.

29. The induction heatable aerosol-generating system according to claim 28,
wherein the temperature sensor is a thermocouple or thermistor mounted on a printed circuit board (PCB) of the aerosol-generating device, or a thermocouple or thermistor mounted within a substrate receiving cavity of an aerosol-generating device,
wherein the aerosol-generating device switches to the safety mode if the temperature of a portion of the aerosol-generating device is determined to be out of a predetermined range, or
wherein operation is terminated if the temperature of a portion of the aerosol-generating device is determined to be out of the predetermined range.

30. The induction heatable aerosol-generating system according to claim 17,
wherein the one or more predetermined criteria of the safety mode are criteria relating to operational events, monitored operational parameters, or derivatives of monitored parameters, and
wherein the controller is further configured to engage the safety mode in response to one or more of the predetermined criteria being met.

31. The induction heatable aerosol-generating system according to claim 30, wherein at least one of the one or more predetermined criteria is selected from the list of criteria consisting of; a temperature of electronic components of the aerosol-generating system exceeding a predetermined temperature, a temperature of a substrate-receiving cavity or chamber of the aerosol-generating system exceeding a predetermined temperature, a temperature of the susceptor exceeding a maximum operating temperature, a temperature of the susceptor exceeding a Curie temperature of a material component of the susceptor, a response of the electrical control parameter to power supplied to the inductive heating arrangement during the heating mode not meeting a predetermined condition, and voltage of the power source falling below a predetermined level.

32. The induction heatable aerosol-generating system according to claim 17, wherein the safety mode comprises one or more steps of: reducing power supplied to the inductive heating arrangement, terminating power supplied to the inductive heating arrangement, initiating another one of the plurality of operational modes, and terminating operation of the induction heatable aerosol-generating system.

33. The induction heatable aerosol-generating system according to claim 17, wherein operating in the safety mode comprises an adjustment to the power provided to the inductive heating arrangement in response to one or more overheating or cooling events.

34. The induction heatable aerosol-generating system according to claim 17, wherein at least a portion of the susceptor is configured to undergo a reversible phase transition when heated or cooled through a predetermined temperature range.

35. The induction heatable aerosol-generating system according to claim 17,
wherein the controller is further configured to identify upper and lower boundary values of the electrical control parameter associated with upper and lower boundaries of the phase transition, and
wherein the target value of the electrical control parameter is set to a value between the upper and the lower boundary values.

36. The induction heatable aerosol-generating system according to claim 17, wherein the re-calibration mode is configured to operate without unduly interrupting the heating mode.
